(19) United States
(12) Patent Application Publication
(10) Pub. No.: US 2013/0159397 A1
(43) Pub. Date: Jun. 20, 2013

(54) COMPUTER PRODUCT, INFORMATION PROCESSING APPARATUS, AND PARALLEL PROCESSING CONTROL METHOD

(71) Applicant: FUJITSU LIMITED, Kawasaki-shi (JP)

(72) Inventors: Koichiro YAMASHITA, Hachioji (JP); Hiromasa Yamashita, Kawasaki-shi (JP); Takahisa Suzuki, Kawasaki (JP); Koji Kurihara, Kawasaki (JP)

(73) Assignee: FUJITSU LIMITED, Kawasaki-shi (JP)

(21) Appl. No.: 13/767,564

(22) Filed: Feb. 14, 2013

Related U.S. Application Data
(63) Continuation of application No. PCT/JP2010/063871, filed on Aug. 17, 2010.

(51) Int. Cl. H04L 29/06

(52) U.S. Cl. CPC H04L 67/42
USPC 709/203

(57) ABSTRACT

A computer-readable recording medium stores a parallel processing control program that causes a connection origin processor to execute a process. The process includes measuring a band between the connection origin apparatus and a connection destination apparatus; calculating, based on the measured band, an execution time period for each execution object for which parallel processing is executable by the connection origin processor in the connection origin apparatus and a connection destination processor in the connection destination apparatus, the execution objects having granularities of the parallel processing that differ from each other; selecting from among the execution objects and based on a length of each calculated execution time period, an execution object to be executed; and setting the selected execution object to be executable by the connection origin processor and the connection destination processor in cooperation with each other.

### CROSS REFERENCE TO RELATED APPLICATIONS

This application is a continuation application of International Application PCT/JP2010/063871, filed on Aug. 17, 2010 and designating the U.S., the entire contents of which are incorporated herein by reference.

### FIELD

The embodiments discussed herein are related to a computer product, an information processing apparatus, and a parallel processing control method that control parallel processing.

### BACKGROUND

Techniques such as thin client processing and server cooperation have recently been disclosed associated with the development of the network technology. Thin client processing includes a terminal device that is operated by a user and that includes an input and output mechanism, and a server that is connected through a network and that executes actual processing. Server cooperation is a technique according to which a terminal device and a server cooperate to provide a specific service.

For example, a technique of executing the thin client processing has been disclosed where a terminal device notifies a server of a request for starting up software corresponding to a load on the terminal device (see, e.g., Japanese Laid-Open Patent Publication No. 2006-252218). Another technique of executing the thin client processing has been disclosed where a server starts up virtual machine software in response to a software start-up request from a terminal device as technique (see, e.g., Japanese Laid-Open Patent Publication No. 2006-107185).

When a terminal device moves, the communication quality of the network varies depending on the position of the terminal device. For example, a technique of determining the communication quality of the network has been disclosed where an index is retained of the communication quality achieved during normal operation of the communication network of the network, whereby normal operation of a line can be determined (see, e.g., Japanese Laid-Open Patent Publication No. 2006-340050).

When the terminal device moves and the communication quality of the network drops, the terminal device may be unable to acquire a result of the processing executed by the server. For example, a technique executed to prevent drops in the communication quality is disclosed where a check point is provided and database data and a status are transferred to a sub system at the time of the check point (see, e.g., Japanese Laid-Open Patent Publication No. 2005-267301).

With the conventional techniques, as far as the thin client processing and the server cooperation is concerned, the processing is executed in the form of executing all the processing using the terminal device or the form of off-loading all the processing on the server. However, with these forms, especially when all the processing is executed using the terminal device, a problem arises in that the performance of the terminal device is the source of a bottleneck.

When, for example, a wide band can be acquired corresponding to the communication quality using a technique that combines the technique disclosed in Japanese Laid-Open Patent Publication No. 2006-252218 or Japanese Laid-Open Patent Publication No. 2006-107185 with the technique disclosed in Japanese Laid-Open Patent Publication No. 2006-340050, the terminal device and the server can execute different distributed software. However, according to this technique, a problem arises in that it is difficult to execute a single software by parallel-processing. For a narrow band, according to the technique disclosed in Japanese Laid-Open Patent Publication No. 2005-267301, a large-scale resource of a database is required and therefore, a problem arises in that cost increases.

### SUMMARY

According to an aspect of an embodiment, a computer-readable recording medium stores a parallel processing control program that causes a connection origin processor to execute a process that includes measuring a band between the connection origin apparatus and a connection destination apparatus; calculating, based on the measured band, an execution time period for each execution object for which parallel processing is executable by the connection origin processor in the connection origin apparatus and a connection destination processor in the connection destination apparatus, the execution objects having granularities of the parallel processing that differ from each other; selecting from among the execution objects and based on a length of each calculated execution time period, an execution object to be executed; and setting the selected execution object to be executable by the connection origin processor and the connection destination processor in cooperation with each other.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a group of apparatuses included in a parallel processing control system 100 according to a first embodiment;

FIG. 2 is a block diagram of a hardware configuration of a terminal device 203 according to the first embodiment;

FIG. 3 is an explanatory diagram of software of the parallel processing control system 100;

FIGS. 4A and 4B are explanatory diagrams of an execution state and an execution time period of parallel processing;

FIG. 5 is an explanatory diagram of the rate of parallel processing and processing performance concerning the number of CPUs;

FIG. 6 is a functional diagram of the parallel processing control system 100;

FIGS. 7A and 7B are explanatory diagrams of an overview of the parallel processing control system 100 at the time of design;

FIG. 8 is an explanatory diagram of an example of an execution object of each granularity;

FIG. 9 is an explanatory diagram of the execution state of the parallel processing control system 100 acquired when fine granularity is selected;

FIG. 10 is an explanatory diagram of the execution state of the parallel processing control system 100 acquired when moderate granularity is selected;

FIG. 11 is an explanatory diagram of the execution state of the parallel processing control system 100 acquired when coarse granularity is selected;

FIG. 12 is an explanatory diagram of the execution state of the parallel processing control system 100 acquired when radio communication 105 is disconnected;

FIGS. 13A and 13B are explanatory diagrams of an example of data protection executed when the granularity of the parallel processing becomes coarser;

FIG. 14 is an explanatory diagram of an example of the execution time period corresponding to each division number of the parallel processing;

FIG. 15 is an explanatory diagram of the execution state of the parallel processing control system 100 for an ad-hoc connection according to a second embodiment;

FIG. 16 is an explanatory diagram of the execution state of the parallel processing control system 100 for a multi-core processor system according to a third embodiment;

FIG. 17 is a flowchart of a start process of the parallel processing by a scheduler 302;

FIG. 18 is a flowchart of a parallel processing control process in a load distributable process executed by the scheduler 302;

FIG. 19 is a flowchart of the data protection process; and

FIG. 20 is a flowchart of a virtual memory setting process.

### DESCRIPTION OF EMBODIMENTS

Preferred embodiments of the present invention will be explained with reference to the accompanying drawings.

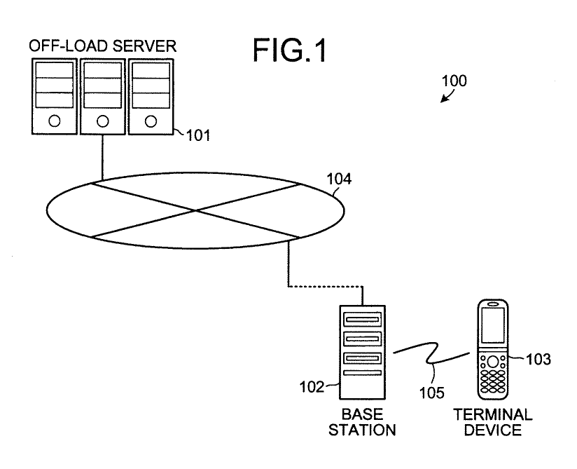

FIG. 1 is a block diagram of a group of apparatuses included in a parallel processing control system 100 according to a first embodiment. The parallel processing control system 100 includes an off-load server 101, a base station 102, and a terminal device 103. The off-load server 101 and the base station 102 are connected by a network 104. The base station 102 and the terminal device 103 are connected by radio communication 105.

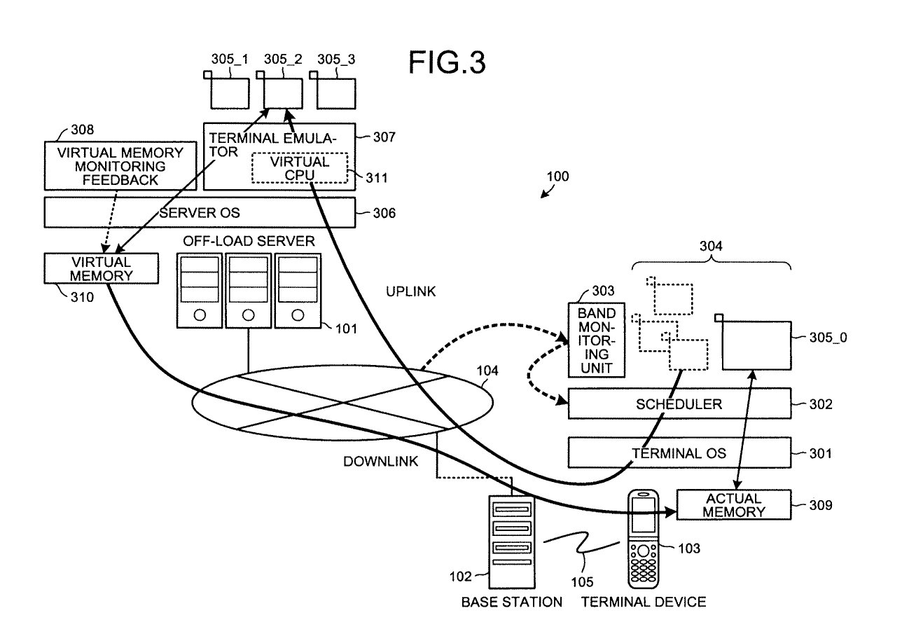

The off-load server 101 is an apparatus that in place of the terminal device 103, executes the processing to be executed by the terminal device 103. For example, the off-load server 101 has an environment where the off-load server 101 can operate the terminal device 103 in a pseudo manner and in place of the terminal device 103, executes the processing to be executed by the terminal device 103 in the environment. The software such as the environment will be described later with reference to FIG. 3.

The base station 102 is an apparatus that executes radio communication with the terminal device 103 and that relays telephone calls and communication to/from other terminals. Plural base stations 102 are present and the plural base stations 102 and the terminal device 103 form a mobile telephone network. The base stations 102 each relay communication between the terminal device 103 and the off-load server 101 through the network 104.

For example, the base station 102 receives data from the terminal device 103 using the radio communication 105 and transmits the data to the off-load server 101 using the network 104. A communication line from the terminal device 103 to the off-load server 101 is an uplink. The base stations 102 each receive packet data from the off-load server 101 using the radio communication 105 and each transmit the packet data to the terminal device 103 using the radio communication 105. The communication line from the off-load server 101 to the terminal device 103 is a downlink.

The terminal device 103 is a device that is operated by a user to use the parallel processing control system 100. For example, the terminal device 103 has a user interface function and receives inputs and outputs from the user. For example, when the parallel processing control system 100 provides a web mail service, the off-load server 101 executes a mail process and the terminal device 103 executes a web browser.

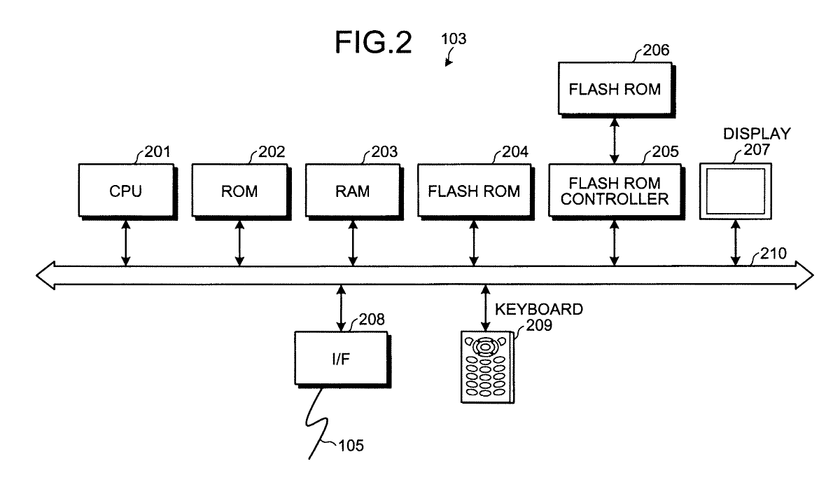

FIG. 2 is a block diagram of a hardware configuration of the terminal device 203 according to the first embodiment. As depicted in FIG. 2, a terminal device 203 includes a central processing unit (CPU) 201, read-only memory (ROM) 202, random access memory (RAM) 203, flash ROM 204, a flash ROM controller 205, and flash ROM 206. The terminal device 203 includes a display 207, an interface (I/F) 208, and a keyboard 209, as input/output devices for the user and other devices. The components of the multi-core system 200 are respectively connected by a bus 210.

The CPU 201 governs overall control of the terminal device 203. The ROM 202 stores programs such as a boot program. The RAM 203 is used as a work area of the CPU 201. The flash ROM 204 stores system software such as an operating system (OS), and application software. For example, when the OS is updated, the terminal device 203 receives a new OS via the I/F 208 and updates the old OS that is stored in the flash ROM 204 with the received new OS.

The flash ROM controller 205, under the control of the CPU 201, controls the reading and writing of data with respect to the flash ROM 206. The flash ROM 206 stores data written under control of the flash ROM controller 205. Examples of the data include image data and video data acquired by the user of the terminal device 103 through the I/F 208. A memory card, SD card and the like may be adopted as the flash ROM 206.

The display 207 displays, for example, data such as text, images, functional information, etc., in addition to a cursor, icons, and/or tool boxes. A thin-film-transistor (TFT) liquid crystal display and the like may be employed as the display 207.

The I/F 208 is connected to the base station 102 through the radio communication 105 and through the base station 102 is connected to the network 104 such as the Internet and is further connected to the off-load server 101 through the network 104. The I/F 208 administers an internal interface with the radio communication 105 and controls the input and output of data with respect to external apparatuses. For example, a modem or a LAN adaptor may be employed as the I/F 208.

The keyboard 209 includes, for example, keys for inputting letters, numerals, and various instructions and performs the input of data. A touch-panel-type input pad or numeric keypad, etc. may be adopted as the keyboard 209.

Though not depicted, the off-load server 101 includes a CPU, a ROM, and a RAM as hardware. The off-load server 101 may include a magnetic disk drive and an optical disk drive as its storage devices. The magnetic disk drive and the optical disk drive each store and read data under the control of the CPU of the off-load server 101.

FIG. 3 is an explanatory diagram of software of the parallel processing control system 100. The software depicted in FIG. 3 include a terminal OS 301, a scheduler 302, a band monitoring unit 303, a process 304, threads 305_0 to 305_3, a server OS 306, a terminal emulator 307, and virtual memory monitoring feedback 308. The threads 305_0 to 305_3 are threads in the process 304. An actual memory 309 and a virtual memory 310 are established in the RAM 203, the RAM of the off-load server 101, etc., as storage areas to be accessed by the software.

The software including the terminal OS 301 to the process 304 and the thread 305_0 are executed by the terminal device 103. The process 304, the threads 305_1 to 305_3, the server OS 306 to the virtual memory monitoring feedback 308 are executed by the off-load server 101.

The terminal OS 301 is software that controls the terminal device 103. For example, the terminal OS 301 provides a library to be used by the thread 305_0, etc. The terminal OS 301 manages memory such as the ROM 202 and the RAM 203.

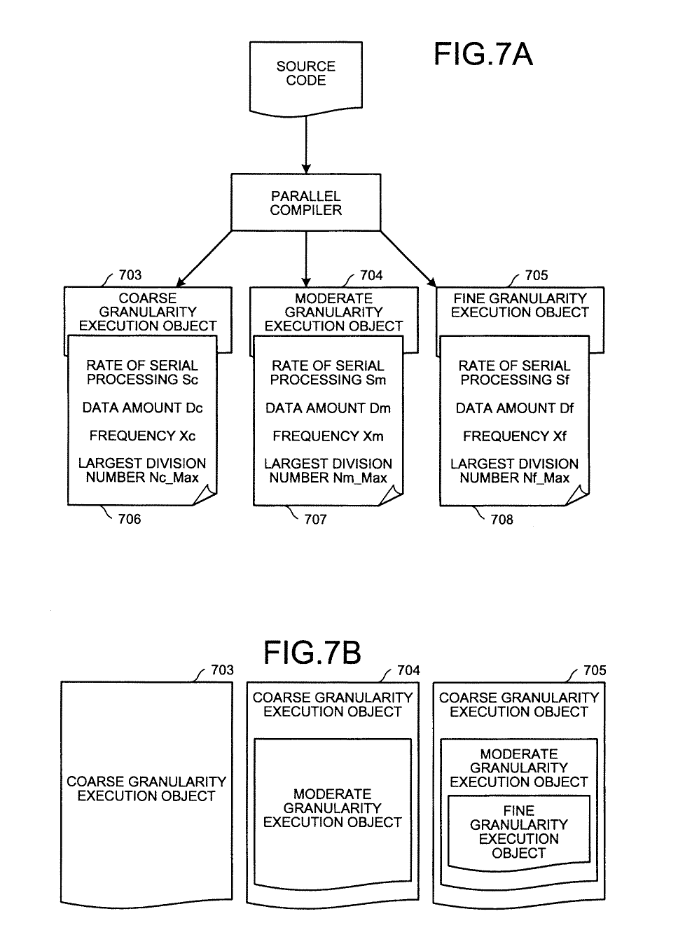

The scheduler 302 is a function provided by the terminal OS 301, and is software that determines a thread to be allocated to the CPU 201 based on the priority level set for the thread or the process, etc. At a predetermined time, the scheduler 302 allocates to the CPU 201, a thread whose dispatch has been determined. The scheduler 302 according to the first embodiment can execute parallel processing; and, when execution objects are present whose granularities of the parallel processing differ from each other, the scheduler 302 selects the optimal execution object and executes the optimal execution object to produce the process 304. The granularity of the parallel processing will be described later in detail with reference to FIGS. 7A and 7B.

The band monitoring unit 303 is software that monitors the band of the network 104 and of the radio communication 105. For example, the band monitoring unit 303 issues “Ping”, measures the speed of each of the downlink and the uplink, and when any variation thereof is present, notifies the scheduler 302 of the variation.

The band monitoring unit 303 may determine that variation is present when, for example, a variation of the band relative to the band acquired at the previous measurement is greater than or equal to a specific threshold value, as a specific variation. Alternatively, the band monitoring unit 303 may also determine that variation is present when the widest band that the parallel processing control system 100 can take is divided into blocks and the blocks are moved. For example, when the widest band is 100 [Mbps], this band is divided into three blocks, whereby a band from 100 to 67 [Mbps] is set to be a wide band; a band from 67 to 33 [Mbps] is set to be a moderate band; and a band from 33 to 0 [Mbps] is set to be a narrow band. The band monitoring unit 303 may also determine that variation is present when the divided blocks are moved such as a move from the wide band to the moderate band and a move from the moderate band to the narrow band.

The process 304 is produced by executing on the CPU 201, the execution object read into the RAM 203, etc. The threads 305_0 to 305_3 are present in the process 304 and execute parallel processing. The process 304 can execute load distribution.

For example, the terminal device 103 transmits the execution object to the off-load server 101 through the radio communication 105 and the network 104. The off-load server 101 produces the threads 305_1 to 305_3. Thereby, the process 304 is executed by the terminal device 103 and the off-load server 101 in a state where the processing load is distributed between the terminal device 103 and the off-load server 101. Hereinafter, a process whose load can be distributed will be referred to as a “load distributable process”. The thread 305_0, under execution by the terminal device 103, accesses the actual memory 309. The threads 305_1 to 305_3, under execution by the off-load server 101, access the virtual memory 310.

The server OS 306 is software that controls the off-load server 101. For example, the server OS 306 provides a library to be used by the threads 305_1 to 305_3, etc. The server OS 306 manages the memories such as the ROM and the RAM of the off-load server 101.

The terminal emulator 307 is software that emulates the terminal device 103 and is also software that enables the execution object executable by the terminal device 103, to be executed by the off-load server 101. For example, the terminal emulator 307 replaces an instruction to the CPU 201 or an instruction to the library of the terminal OS 301 that is described in the execution object respectively with an instruction to the CPU of the off-load server 101 or an instruction to the library of the server OS 306; and executes the instruction after the replacement.

In the state depicted in FIG. 3, the off-load server 101 executes the threads 305_1 to 305_3 using the terminal emulator 307. The execution of the terminal emulator 307 causes the parallel processing control system 100 to present an aspect thereof as a multi-core processor system according to which it is assumed that the CPU 201 is a master CPU and the off-load server 101 assumes that a virtual CPU 311 is a slave CPU.

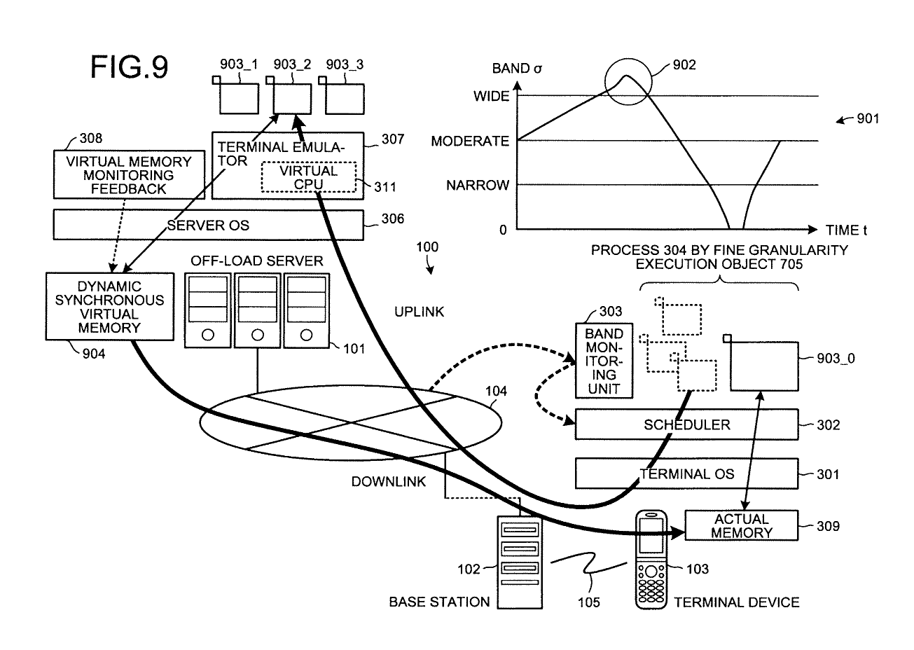

The virtual memory monitoring feedback 308 is software that writes data written in the virtual memory 310 back into the actual memory 309. For example, the virtual memory monitoring feedback 308 monitors access of the virtual memory 310 and writes the data written to the virtual memory 310 back into the actual memory 309 through the downlink. The virtual memory 310 is an area to store the same addresses as those in the actual memory 309 and the virtual memory monitoring feedback 308 executes the process of writing back at a predetermined timing. The predetermined timing differs according to the granularity of the parallel processing of the process 304. The timing to write back will be described later with reference to FIGS. 9 to 12.

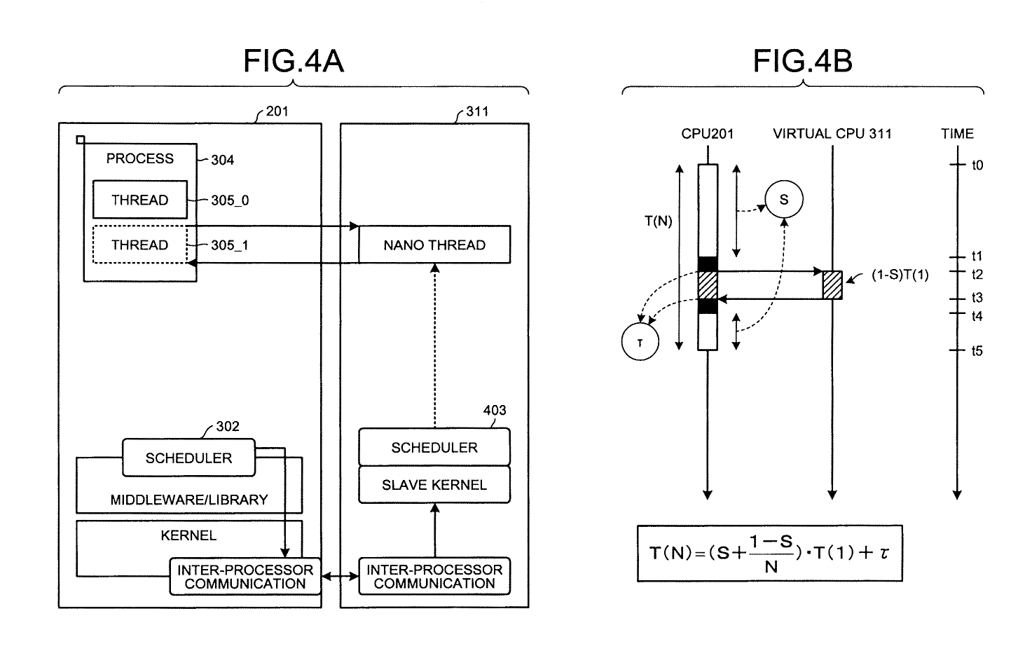

FIGS. 4A and 4B are explanatory diagrams of the execution state and the execution time period of the parallel processing. FIG. 4A depicts the execution state of the process 304 in the state where the CPU 201 is used as the master CPU and the virtual CPU 311 by the terminal emulator 307 of the off-load server 101 is used as the slave CPU. FIG. 4B depicts the execution time period when the process 304 is executed in the execution state denoted by the reference numeral “FIG. 4A”.

In FIG. 4A, the CPU 201 executes the thread 3050 included in the process 304, which is a load distributable process, using middleware or the library. The CPU 201 notifies the virtual CPU 311 of the thread 305_1 included in the process 304 from a kernel of the terminal OS 301 using inter-processor communication. The content notified may be a memory dump of the thread context of the thread 305_1 or, a start address, information concerning the argument, the size of a stack memory, etc. required to execute the thread 305_1. According to the content notified, the virtual CPU 311 allocates the thread 3051 as a nano-thread using a slave kernel and a scheduler 403.

FIG. 4B depicts the execution time period of the process 304. At time to, the CPU 201 starts the execution of the process 304. During a time period from time t0 to time t1, the CPU 201 executes a process for which no parallel processing can be executed; and for which serial processing is required. When the CPU 201 detects a process for which the parallel processing can be executed at time t1, the CPU 201 notifies the virtual CPU 311 of the information required to execute the parallel processing, via inter-processor communication during a time period from time t1 to time t2. The CPU 201 and the virtual CPU 311 process the process 304 in parallel during a time period from time t2 to time t3.

When the parallel execution comes to an end at time t3, the virtual CPU 311 notifies the CPU 201 of the result of the executed parallel processing, via inter-processor communication during a time period from time t3 to time t4. The CPU 201 again executes serial processing during a time period from time t4 to time t5 and causes the processing of the process 304 to come to an end. As a result, a time period from time t0 to time t5, which is the execution time period T(N) of the process 304, can be acquired using Eq. (1) below.

T(N)=(S+(1−S)/N)·T(1)+τ (1)

Where, “N” is the number of CPUs that can execute a load distributable process; “T(N)” is the execution time period of the load distributable process executed when the number of CPUs is N; “S” is the rate of execution of the serial processing for the load distributable process; and “τ” is the communication time period associated with the serial processing. Hereinafter, “N”, “S”, and “τ” will respectively be referred to as “number of CPUs”, “rate of the serial processing”, and “communication time period”. Using the rate S of the serial processing, the rate of the parallel processing is “100−S [%]”.

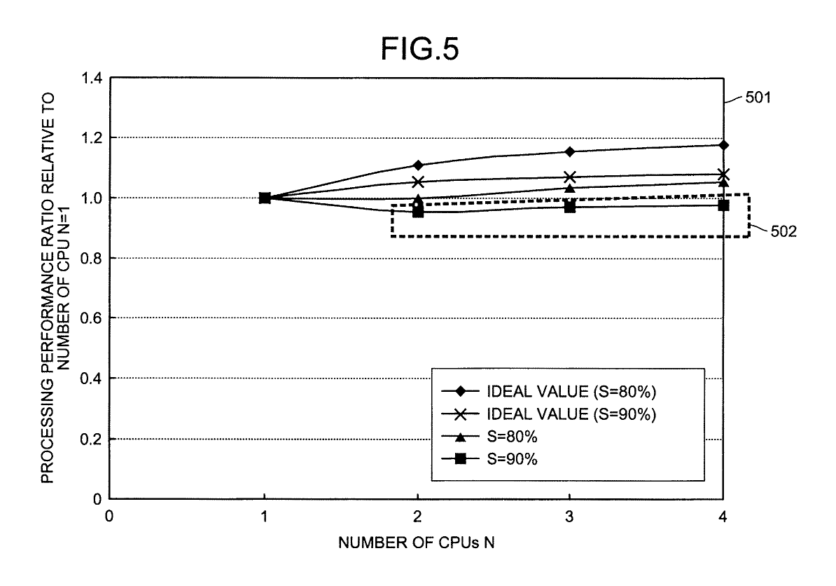

FIG. 5 is an explanatory diagram of the rate of the parallel processing and the processing performance concerning the number of CPUs. The horizontal of a graph 501 represents the number of CPUs “N” and the vertical axis represents the processing performance ratio relative to that acquired when the number of CPU N is N=1. In an ideal state where the communication time period τ is zero and no overhead is generated concerning the communication, the processing performance improves as the number of CPUs is increased for both of the rates S of the serial processing that are S=80 [%] and S=90 [%].

However, when the communication time period τ is τ=0.1T(1) and overhead is generated concerning the communication, for the rate S of the serial processing that is S=90 [%], the points plotted for 2 to 4 CPUs are inside a rectangle 502 that is a region representing a processing performance ratio that is less than 1. As described, when overhead is generated concerning the communication, the processing performance ratio may drop consequent to executing parallel processing, depending on the rate of the parallel processing or the serial processing.

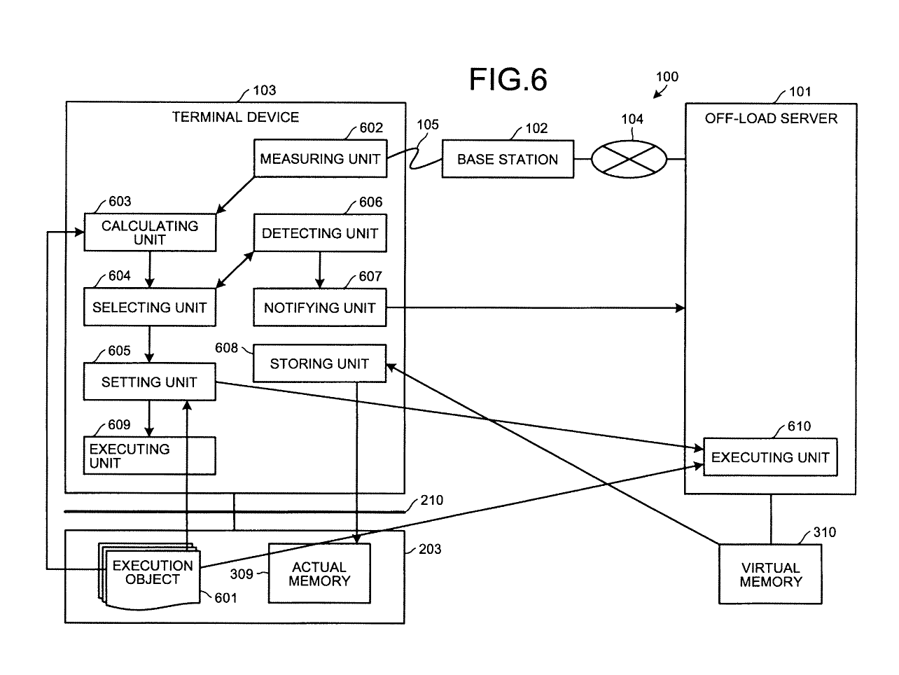

FIG. 6 is a functional diagram of the parallel processing control system 100. The parallel processing control system 100 includes a measuring unit 602, a calculating unit 603, a selecting unit 604, a setting unit 605, a detecting unit 606, a notifying unit 607, a storing unit 608, and executing units 609 and 610. These functions forming a control unit (the measuring unit 602 to the executing unit 610) are implemented by executing on the CPU 201, programs stored in a storage device. The storage device is, for example, the ROM 202, the RAM 203, the flash ROMs 204 and 206 that are depicted in FIG. 2. The functions may be implemented by executing on another CPU, programs via the I/F 208.

The terminal device 103 can access an execution object 601 that is stored in a storage device such as the ROM 202 or the RAM 203. Among the functional units, the units from the measuring unit 602 to the executing unit 609 are functions of the terminal device 103 that includes the CPU 201, which is the master CPU. The executing unit 610 is a function of the off-load server 101 that includes the virtual CPU 311, which is a slave CPU.

The measuring unit 602 has a function of measuring the band between a connection origin apparatus and a connection destination apparatus. For example, the measuring unit 602 measures a band σ between the terminal device 103 (connection origin apparatus) and the off-load server 101 (connection destination apparatus). For example, the measuring unit 602 transmits the “Ping” to the off-load server 101 and measures the downlink and the uplink using response time periods of the “Ping”. The measuring unit 602 is a part of the function of the band monitoring unit 303. The extracted data is stored in the storage area such as a register or a cache memory of the CPU 201 or the RAM 203.

The calculating unit 603 has a function of calculating based on the band measured by the measuring unit 602, an execution time period of each of the execution objects that can be processed in parallel by the connection origin processor of the connection origin apparatus and the connection destination processor of the connection destination apparatus and that have differing granularities of parallel processing. The granularity of the parallel processing represents the amount of sub-processing to be executed in parallel to execute a specific process. The amount of sub-processing becomes smaller as the granularity becomes finer, and the amount of sub-processing becomes larger as the granularity becomes coarser. For example, parallel processing executed for each statement is parallel processing whose granularity is fine, and parallel processing executed for each thread, each function, etc. is parallel processing whose granularity is coarse. Parallel processing executed repeatedly using a loop is parallel processing whose granularity is moderate.

For example, the calculating unit 603 calculates based on the band σ, an execution time period for each of the execution objects that can be processed in parallel by the CPU 201 and the virtual CPU 311 and whose granularities of parallel processing differ. For example, the calculating unit 603 calculates the execution time period by adding a value obtained by dividing the communication amount to be the overhead of the parallel processing by the band σ, to the processing time period of the parallel processing. Because the overhead becomes conspicuous when the band σ is a narrow band, the calculating unit 603, for example, may set a specific threshold value σ0 and, when the band σ becomes lower than the threshold value σ0, may calculate the execution time period by adding a value obtained by dividing the communication amount by the band σ, to the processing time period of the parallel processing.

The calculating unit 603 may first calculate the communication time period using the band and the communication amount concerning the parallel processing. The calculating unit 603 may continuously calculate the processing time period for parallel execution of the execution objects, using the processing time period, the rate of the serial processing in the parallel processing, and the largest division number that enables the parallel execution in the parallel processing that are acquired when the parallel processing is serially executed. The calculating unit 603 may respectively calculate the execution time period of the execution objects by adding the communication time period and the processing time period for the parallel execution.

The rate of the serial processing in the parallel processing is the rate of the portion remaining after excluding the portion that can be executed in parallel of the specific process. The calculating unit 603 may calculate the execution time period using the rate of the portion that can be executed in parallel of the specific process. The parallel processing control system 100 according to the first embodiment calculates the execution time period using the rate S of the serial processing. The calculated communication time period is equal to the communication time period τ, which is the second term of Eq. (1). The calculated processing time period for the parallel execution is equal to (S+(1−S)/N·T(1), which is the first term of Eq. (1).

For example, it is assumed that the calculating unit 603 calculates the execution time period for an execution object whose granularity of the parallel processing is coarse. When the band σ is 10 [Mbps] and the communication amount concerning the parallel processing is 76,896 [bits], the calculating unit 603 calculates the communication time period to be the amount of the communication/the band σ=about 3.0 [milliseconds]. When the processing time period for serial execution is 7.5 [milliseconds], the rate S of the serial processing is 0.01 [%], and the largest division number N_Max enabling the parallel execution is 2, the calculating unit 603 calculates the processing time period for the parallel execution to be 3.8 [milliseconds]. The calculating unit 603 finally calculates the execution time period of the coarse granularity execution object to be 3.0+3.8=6.8 [milliseconds]. Similarly, the calculating unit 603 calculates the execution time periods of the execution objects concerning the other granularities.

The calculating unit 603 may calculate the processing time period for parallel execution, using the processing time period for the serial execution, the rate of the serial processing, and the number of the parallel execution sessions that is less than or equal to the largest division number. The calculating unit 603 may continuously calculate the execution time period for each number of parallel execution sessions of the execution objects by adding the communication time period, and the processing time period for the parallel execution.

For example, when the largest division number is two for the execution object whose granularity of the parallel processing is coarse, the calculating unit 603 calculates the execution time period to be 7.5 [milliseconds] for 1 parallel execution session and to be 6.8 [milliseconds] for 2 parallel execution sessions, from Eq. (1). The calculated result is stored to a storage area such as a register or a cache memory of the CPU 201 or the RAM 203.

The selecting unit 604 has a function of selecting the execution object to be executed from among the execution objects, based on the length of each of the execution time periods calculated by the calculating unit 603. The selecting unit 604 may select the execution object whose execution time period is the shortest among the execution time periods, as the execution object to be executed. For example, when the calculated execution time periods of the execution objects are 7.5 and 6.8 [milliseconds], the selecting unit 604 may select the execution object whose execution time period is 6.8 [milliseconds], which is the shortest.

When the execution objects are switched after the selection, overhead is also generated by the switching and therefore, the selecting unit 604 may select the execution object after addition of the switching overhead, as a method of selecting the execution time period not using the shortest one. For example, it is assumed that the difference in the execution time period is trivial between an execution object currently selected and another execution object and the execution time period of the other execution object is the shortest. The selecting unit 604 may select the execution time period of the execution object currently selected when the execution time period of the execution object currently selected is exceeded by the result of adding the overhead time period for the switching to the execution time period of the other execution object.

In a case where connection is established through a mobile telephone network, when the detecting unit 606 detects the start of the execution of the parallel processing, the selecting unit 604 may select the execution object whose granularity is the coarsest as the execution object to be executed. For example, after the detection, the selecting unit 604 selects the coarse granularity execution object. The result of the selection is stored to a storage area such as a register or a cache memory of the CPU 201 or the RAM 203.

The setting unit 605 has a function of setting the execution object that is selected by the selecting unit 604, to be executable by the connection origin processor and the connection destination processor in cooperation with each other. “Cooperation” means that the connection origin processor and the connection destination processor operate in cooperation with each other. For example, when the selecting unit 604 selects the coarse granularity execution object whose granularity of the parallel processing is coarse, the setting unit 605 sets the coarse granularity execution object to be executable by the CPU 201 and the virtual CPU 311.

For example, the CPU 201 transfers the data of the coarse granularity execution object to be executed to the virtual CPU 311 and sets the coarse granularity execution object to be executable. If the terminal emulator 307 is not started up, the CPU 201 causes the off-load server 101 to start up the terminal emulator 307 and sets the coarse granularity execution object to be executable.

The setting unit 605 may set the execution object to be executable by a group of processors in cooperation with each other that includes a specific connection origin processor and a specific connection destination processor and whose division number is the largest, among the groups of processors of the connection origin apparatus and the connection destination apparatus. The “specific connection origin processor” refers to a processor that is the master when the terminal device 103 has multiple cores. The “specific connection destination processor” refers to a processor that is the master when the off-load server 101 has multiple cores. The processor to be the master of the off-load server 101 can be, for example, a processor that executes a response to the “Ping” among the processors to which the “Ping” was issued by the measuring unit 602 of the terminal device 103.

For example, a case is assumed where the largest division number is four when the processor of the connection origin apparatus is one and the processors of the connection destination apparatus are four. The setting unit 605 sets the execution object to be executable by a total of four CPUs in cooperation with each other, including the CPU 201 of the terminal device 103 and three CPUs including the master CPU of the off-load server 101.

The setting unit 605 may set the execution object to be executable by a group of processors in cooperation with each other of a number that is the number of the parallel execution sessions for the execution object to be executed, among the groups of processors of the connection origin apparatus and the connection destination apparatus. The group of processors includes the specific connection origin processor and the specific connection destination processor.

For example, it is assumed that the largest division number is four and the number of parallel execution sessions is three for the execution object to be executed when the processor of the connection origin apparatus is one and the processors of the connection destination apparatus is four. The setting unit 605 sets the execution object to be executable by a total of three CPUs in cooperation with each other that are the CPU 201 of the terminal device 103 and two CPUs including the master CPU of the off-load server 101.

The detecting unit 606 has a function of detecting that the selection by the selecting unit 604 selects a new execution object to be executed whose granularity is coarser than that of the execution object to be executed. For example, the detecting unit 606 detects that a fine granularity execution object whose granularity of the parallel processing is fine is changed to a moderate granularity execution object whose granularity of the parallel processing is moderate or that a moderate granularity execution object is changed to a coarse granularity execution object.

When the execution object whose granularity is the coarsest is selected as the execution object to be executed, the detecting unit 606 may detect the state where the band is decreased. For example, when the coarse granularity execution object is selected, the detecting unit 606 detects a state where the band σ is decreased. When average values of the band are taken at intervals of a specific time period and an average value is lower than the previous average value of the band, the detecting unit 606 may detect that the band has decreased as the state where the band σ is decreased. When the band is lower than the specific threshold value, the detecting unit 606 may detect this as a decrease of the band.

When the connection origin apparatus and the connection destination apparatus are connected to each other through the mobile telephone network, the detecting unit 606 may detect that the start of the execution of the parallel processing. For example, when the terminal device 103 is connected to the off-load server 103 through the base station 102 that is a part of the mobile telephone network, the detecting unit 606 detects that the execution of the parallel processing is started. The result of the detection is stored to a storage area such as a register or a cache memory of the CPU 201 or the RAM 203.

The notifying unit 607 has a function of notifying the connection destination apparatus of a transmission request for the result of the processing by the execution object to be executed before the change that is retained by the connection destination apparatus when the detecting unit 606 detects that the new coarse granularity execution object to be executed is selected. For example, the notifying unit 607 notifies the off-load server 101 of a transmission request for the result of the processing by the execution object to be executed before the change that is retained by the virtual memory 310 of the off-load server 101.

The notifying unit 607 has a function of notifying the connection destination apparatus of a transmission request for the result of the processing by the execution object to be executed; and retained by the connection destination apparatus in a case where the detecting unit 606 detects that the band is decreased when the execution object whose granularity is the coarsest is selected. For example, the notifying unit 607 notifies the off-load server 101 of the transmission request for the result of the processing by the execution object to be executed before the change that is retained by the virtual memory 310 of the off-load server 101 when the detecting unit 606 detects the decrease.

The storing unit 608 has a function of storing the processing result by the transmission request notified of by the notifying unit 607, in the storage device of the connection origin apparatus. For example, the storing unit 608 stores the processing result by the transmission request, in the actual memory 309.

The executing units 609 and 610 each have a function of executing an execution object to be executed that is set by the setting unit 605 to be executable. For example, when the coarse granularity execution object is the execution object to be executed, the executing units 609 and 610 respectively cause the terminal device 103 and the off-load server 101 to execute the coarse granularity execution object.

FIGS. 7A and 7B are explanatory diagrams of an overview of the parallel processing control system 100 at the time of design. FIG. 7A depicts the state of production of the execution objects, and FIG. 7B depicts the details of the execution objects.

In FIG. 7A, a parallel compiler produces the execution object, executing a structural analysis, from a source code that becomes the process 304 when the source code is executed. According to the granularity of the parallel processing, the parallel compiler produces a coarse granularity execution object 703, an moderate granularity execution object 704, and a fine granularity execution object 705 that respectively support the coarse granularity, the moderate granularity, and the fine granularity. The parallel compiler also produces a structural analysis result 706 for the coarse granularity execution object 703, a structural analysis result 707 for the moderate-granularity execution object 704, and a structural analysis result 708 for the fine granularity execution object 705.

Each of the structural analysis results 706 to 708 has the rate S of the serial processing in the entire processing, the data amount D that is generated in the parallel processing, the frequency X at which the parallel processing occurs, and the largest division number N_Max that enables the parallel execution, described therein that are acquired by the structural analysis. In the following description, symbols indicating the coarse granularity, the moderate granularity, and the fine granularity will respectively be “c”, “m”, and “f”.

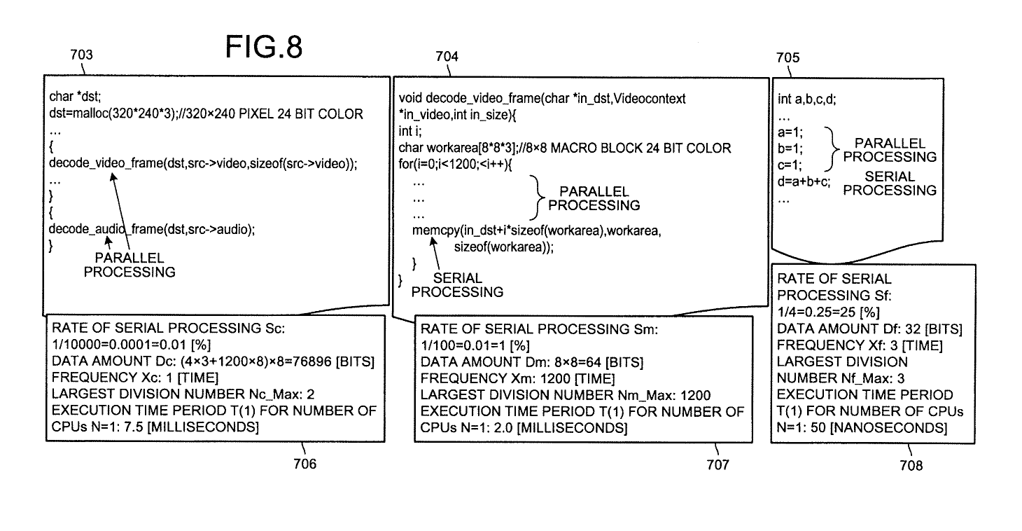

The granularities of the parallel processing will be described. The parallel processing at the coarse granularity refers to, as blocks that are each a series of processes in a program, parallel-execution of the blocks when no dependence relation is present among the series of blocks. The parallel processing at the moderate granularity refers to, in a loop process, parallel execution of the repeated portions when no dependence relation is present among the repeated portions of the loop. The parallel processing at the fine granularity refers to parallel execution of statements when no dependence relation is present among the statements. An example will be described later with reference to FIG. 8 for the granularities and the structural analysis results 706 to 708.

FIG. 7B depicts the details of the coarse granularity execution object 703 to the fine granularity execution object 705. The coarse granularity execution object 703 has description indicating that a series of blocks in the program are executed in parallel. The moderate granularity execution object 704 has description indicating that loop processes in a block are further executed in parallel in the state where the coarse granularity execution object 703 has description indicating that a series of blocks in the program are executed in parallel. The fine granularity execution object 705 has description indicating that the statements are executed in parallel in the state where the series of blocks in the program are executed in parallel and the loop processes in the block are further executed in parallel.

As described, the moderate granularity execution object 704 and the fine granularity execution object 705 each may or may not have to execute the parallel processing whose granularity is coarser than its corresponding granularity. In the above example, the parallel processing whose granularity is coarse is executed. However, for example, the moderate granularity execution object 704 may be produced not to execute, in parallel, the series of blocks in the program and to execute, in parallel, the loop process.

The execution object whose granularity is fine can execute parallel processing whose granularity is coarser than its corresponding granularity and therefore, the parallel processing can be divided into more portions as the granularity becomes finer and the communication amount is increased by the amount generated by the division into more portions. Therefore, the execution object whose granularity is fine and whose communication amount is large is executed in the wide band and the execution object whose granularity is coarse and whose communication amount is small is executed in the narrow band. Thereby, the parallel processing control system 100 can execute the optimal parallel processing corresponding to the band and can improve its processing performance.

FIG. 8 is an explanatory diagram of an example of an execution object of each granularity. FIG. 8 depicts an example of the coarse granularity execution object 703 to the fine granularity execution object 705 and the structural analysis results 706 to 708 for the processing executed when a specific frame of a moving image is decoded.

The coarse granularity execution object 703 is produced to execute in parallel, a function that executes the decoding. For example, the coarse granularity execution object 703 produces a process that executes in parallel, a block including a “decode_video_frame( )” function and a block including a “decode_audio_frame( )” function, using the terminal device 103, etc.

A value of the structural analysis result 706 will be described. Because the two blocks are present that can be executed in parallel, the largest division number Nc_Max enabling the parallel execution is two. When 10,000 statements are present in the “decode_video_frame( )” function and one statement thereof is for serial processing, the rate Sc of the serial processing is 1/10,000=0.00001=0.01 [%]. The data amount Dc is the data size of the argument of the “decode_video_frame( )” function. The frequency Xc is one at which the argument is delivered. For example, Dc is a value obtained by totaling the sizes of arguments “dst” and “src->video”, the size of the calculation result of “sizeof(src->video)”, and the value of a third argument that is the actual data of a second argument.

A case is assumed where a quarter video graphics array (QVGA) is employed for the display 207 having 320×240 pixels and a macro block to be a unit for an image compression process is 8×8 pixels. In this case, with the QVGA, (320×240)/(8×8)=1,200 macro blocks are present. For simplification of the description, a case is assumed where the average size of one macro block is 8 [bytes]. Therefore, “src->video” includes 1,200 macro blocks and “sizeof(src->video)” is at least 1,200×8 [bytes]. From the above, Dc is (4×3+1,200×8)×8=76,896 [bits].

The parallel compiler may calculate the execution time period T(1) for the number of CPU N when N=1 from, for example, the number of steps to be executed; and the clock time period for one instruction of the CPU 201, or may store therein a value acquired from execution by the profiler. In the example of FIG. 8, the execution time period T(1) is T(1)=7.5 [milliseconds]. In Eq. (1), the terminal device 103 calculates the communication time period τ according to the data amount D·the frequency X/the band σ. Assuming that the band σ is 25 [Mbps], the terminal device 103 calculates the execution time period for the number of CPUs N that is N=2 to acquire a result as below.

(0.0001+(1−0.0001)/2)×0.0075+76896/(25×1000×1000)

Because T(1) and T(2) are T(1)=7.5 and T(2)=6.8 [milliseconds], the processing can be executed more quickly when the parallel processing is executed with the number of CPUs N where N=2 for the coarse granularity.

The moderate granularity execution object 704 is produced to execute in parallel, the loop process to process the macro blocks in a function to execute the decoding. For example, the moderate granularity execution object 704 produces a process to execute in parallel, a loop process whose variable “i” for the loop portion varies from zero to a number smaller than 1,200, for each variable i. For example, the produced process executes the parallel execution in a manner of executing the processes as, for example, a process to execute the process whose variable i varies from zero to 599 and the process whose variable i varies from 600 to 1,199.

A value of the structural analysis result 707 will be described. Because the number of repeated processing sessions for the loop is 1,200, the largest division number Nm_Max enabling the parallel execution is 1,200. When 100 statements are present in the loop process and, of these statements, one statement is present for the serial processing described in the moderate granularity execution object 704, the rate Sm of the serial processing is 1/100=0.01=1 [%]. The data amount Dm is the size of one macro block and is 8×8=64 [bits]. The frequency Xm is 1,200 times to transfer the macro block data.

It is assumed that the execution time period T(1) for the number of CPU N that is N=1 is 2.0 [milliseconds]. The terminal device 103 determines the band σ as 50 [Mbps] and calculates the execution time period for the number of CPUs N that is N=2 to acquire the result as below.

(0.01+(1−0.01)/2)×0.0020+600×8×8/(50×1000×1000)≈0.0018=1.8 [milliseconds]

In the above calculation equation, no data transfer needs to be executed for the macro blocks processed by the terminal device 103 when the number of CPUs N is N=2 and therefore, the data transfer frequency is set to be 1,200×(½)=600. The terminal device 103 calculates the execution time period for the number of CPUs N that is N=3 to acquire the result as below.

(0.01+0.99/3)×0.0020+800×8×8/(50×1000×1000)≈0.0017=1.7 [milliseconds]

Similarly, taking into consideration that no data transfer needs to be executed for the macro blocks processed by the terminal device 103, the data transfer frequency is set to be 1,200×(⅔)=800. From the above, T(1), T(2), and T(3) are T(1)=2.0, T(2)=1.8, and T(3)=1.7 [milliseconds] and therefore, for the moderate granularity, the processing can more quickly be executed when the parallel processing is executed with the number of CPUs N that is N=3.

The loop process is processed in parallel in the parallel processing at the moderate granularity and therefore, for example, when another loop process is present in the loop process, two kinds of moderate granularity execution objects can be produced.

The fine granularity execution object 705 is produced to execute in parallel, each statement in processing a macro block. For example, the moderate granularity execution object 704 produces a process to execute in parallel, a process for “a=1:”, “b=1:”, and “c=1:”.

A value of the structural analysis result 708 will be described. The statements among which no dependence relation is present are three and therefore, the largest division number Nf_Max enabling the parallel execution is three. The rate Sf of the serial processing is ¼=0.25=25 [%] from the three statements among which no dependence relation is present and one statement that has a dependence relation. The data amount Df is 32 [bits], which is the size of one variable and the frequency is three because three sessions are present.

It is assumed that the execution time period T(1) for the number of CPU N is N=1 is 50 [nanoseconds]. The terminal device 103 determines the band σ as 25 [Mbps] and calculates the execution time period for the number of CPUs N that is N=3 to acquire the result as below.

(0.25+(1−0.25)/3)×50×10̂(−9)+32×3/(75×1000×1000)≈1.3×10̂(−6)=1.3 [microseconds]

From the above, T(1) and T(3) are T(1)=50 [nanoseconds] and T(3)=1.3 [microsecond] and therefore, for the fine granularity, the processing can be executed more quickly when the serial processing is executed without executing any parallel processing.

For the fine granularity parallel processing, when a statement is present having at least one line that includes plural operators, the fine granularity parallel processing is present. Therefore, the appearance frequency of the fine granularity parallel processing is high. For example, fine granularity parallel processing often occurs in the parallel processing at the coarse granularity and at the moderate granularity.

An execution object whose granularity is fine can execute parallel processing whose granularity is coarser than its corresponding granularity as described with reference to FIGS. 7A and 7B. For example, when the moderate granularity execution object 704 also executes the coarse granularity parallel processing, the largest division number is the number obtained by totaling Nm_Max that is Nm_Max=1,200 presented in the “decode_video_frame( )” function and the division number in the “decode_audio_frame( )” function. Similarly, when the fine granularity execution object 705 also executes the moderate granularity parallel processing, the largest division number is 1,200×3=3,600.

FIG. 9 is an explanatory diagram of the execution state of the parallel processing control system 100 acquired when the fine granularity is selected. In a graph 901, the horizontal axis represents time t and the vertical axis represents the band σ. The parallel processing control system 100 depicted in FIG. 9 is in a state where the system 100 is in a region 902 after acquiring a wide band in the graph 901. The parallel processing control system 100 detects acquisition of the wide band using the band monitoring unit 303, and distributes the load in the process 304 executed by the fine granularity execution object 705.

For example, the terminal device 103 executes a thread 903_0 in the process 304 and the off-load server 101 executes threads 903_1 to 903_3 in the process 304. When the fine granularity execution object 705 executes the process 304, the virtual memory 310 is set to be a dynamic synchronous virtual memory 904. The dynamic synchronous virtual memory 904 is always synchronized with the actual memory 309 for any writing by the threads 903_1 to 903_3.

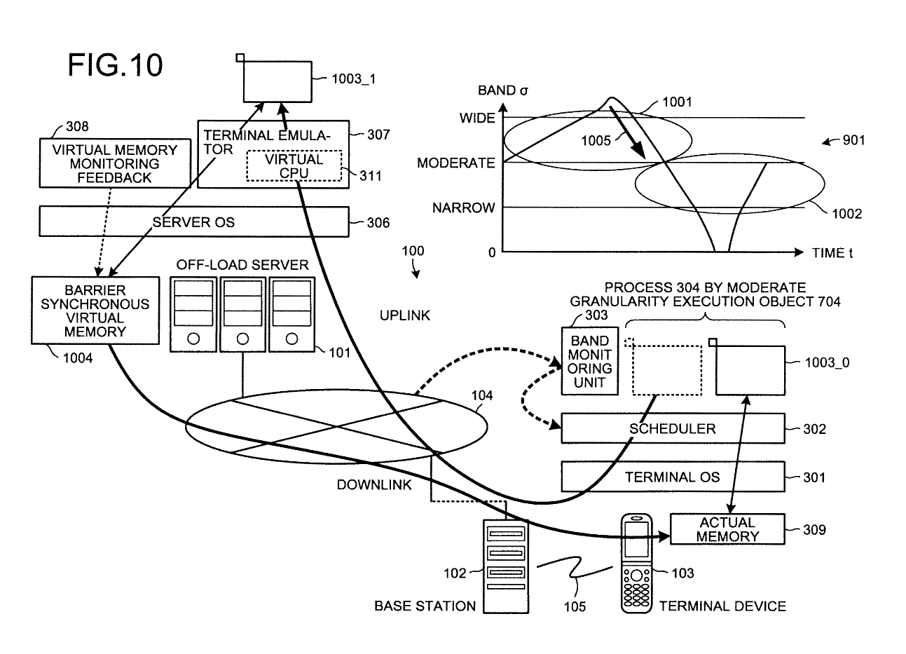

FIG. 10 is an explanatory diagram of the execution state of the parallel processing control system 100 acquired when the moderate granularity is selected. The parallel processing control system 100 depicted in FIG. 10 is in the state where the system 100 is in a region 1001 or 1002 after acquiring an moderate band in the graph 901. The “moderate band” is, for example, a region that is moderate with respect to the entire band. When the entire band is 100 [Mbps], the moderate band may be, for example, 33 to 67 [Mbps]. The parallel processing control system 100 detects the acquisition of the moderate band using the band monitoring unit 303, and distributes the load in the process 304 executed by the moderate granularity execution object 704.

For example, the terminal device 103 executes a thread 1003_0 in the process 304 and the off-load server 101 executes a thread 1003_1 in the process 304. When the moderate granularity execution object 704 executes the process 304, the virtual memory 310 is set to be a barrier synchronous virtual memory 1004. The barrier synchronous virtual memory 1004 is synchronized with the actual memory 309 each time partial processing comes to an end in the thread 1003_1.

When the granularity is switched from the fine granularity to the moderate granularity as indicated by an arrow 1005, the parallel processing control system 100 causes the actual memory 309 to reflect the content of the dynamic synchronous virtual memory 904. Thereby, the virtual memory 310 can be protected even when the granularity is changed.

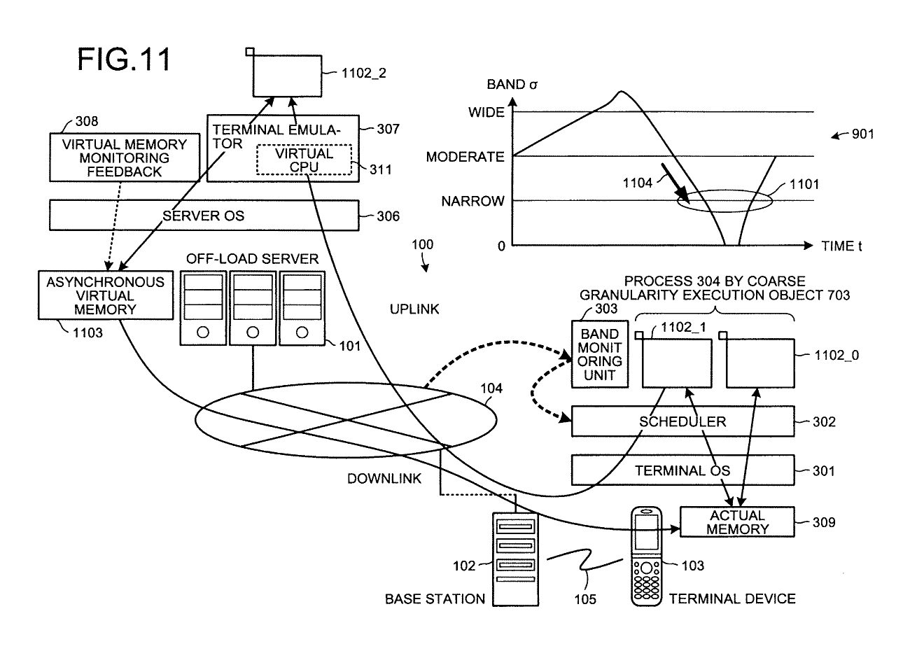

FIG. 11 is an explanatory diagram of the execution state of the parallel processing control system 100 acquired when the coarse granularity is selected. The parallel processing control system 100 depicted in FIG. 11 is in a state of a region 1101 where the system 100 acquires a narrow band in the graph 901. The parallel processing control system 100 detects the acquisition of the narrow band using the band monitoring unit 303, and distributes the load in the process 304 executed by the coarse granularity execution object 703.

For example, the terminal device 103 executes threads 1102_0 and 1102_1 in the process 304 and the off-load server 101 executes a thread 1102_2 in the process 304. When the coarse granularity execution object 703 executes the process 304, the virtual memory 310 is set to be a asynchronous virtual memory 1103. The asynchronous virtual memory 1103 is synchronized with the actual memory 309 when the thread 1102_2 is started up and comes to an end.

When the granularity is switched from the moderate granularity to the coarse granularity as indicated by an arrow 1104, the parallel processing control system 100 causes the actual memory 309 to reflect the content of the barrier synchronous virtual memory 1004. Thereby, the virtual memory can be protected even when the granularity is changed.

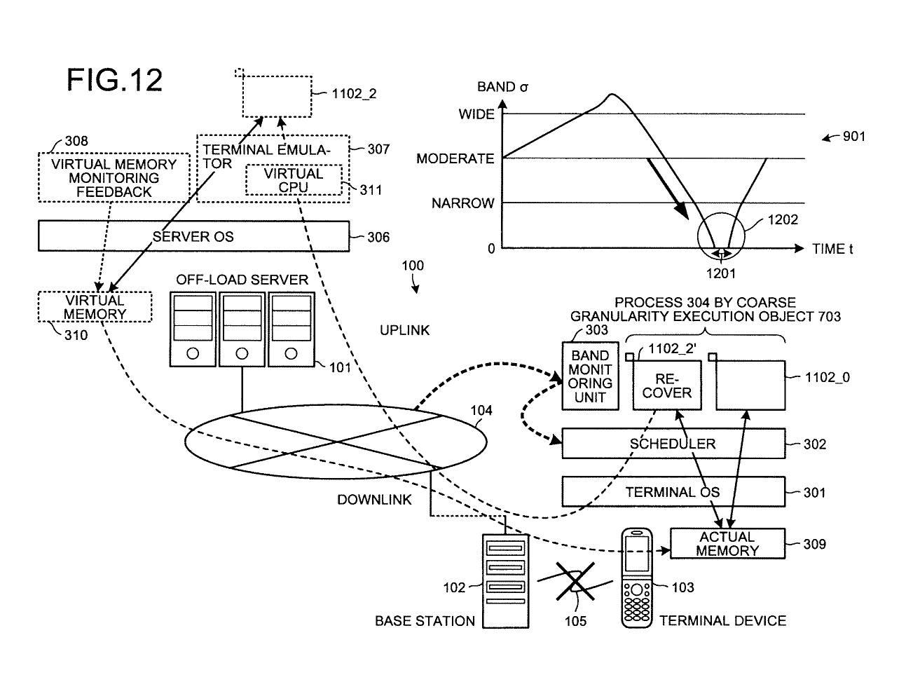

FIG. 12 is an explanatory diagram of the execution state of the parallel processing control system 100 acquired when the radio communication 105 is disconnected. The band σ is zero at a time 1201 in the graph 901. The parallel processing control system 100 depicted in FIG. 12 is in a state where the system 100 is in a region 1202 after acquiring the narrow band in the graph 901 and also in a state where the system 100 detects that the temporal variation (d/dt)σ(t) of the band σ is (d/dt)σ(t)<0. The parallel processing control system 100 detects that the temporal variation (d/dt)σ(t) of the band σ is (d/dt)σ(t)<0 using the band monitoring unit 303, stops the load distribution, and executes the process 304 by the coarse granularity execution object 703 using the terminal device 103.

For example, in a case where the coarse granularity is selected, when the parallel processing control system 100 detects that the temporal variation (d/dt)σ(t) is (d/dt)σ(t)<0, the system 100 transfers the data content of the asynchronous virtual memory 1103 to the actual memory 309. The parallel processing control system 100 also transfers context information on the thread 1102_2 executed by the off-load server 101 to the terminal device 103 and continuously executes the processing as a thread 1102_2′ using the terminal device 103. When the transfer of the data content of the asynchronous virtual memory 1103 is late for the disconnection of the line of the radio communication 105, the terminal device 103 again starts up the process 304 from the coarse granularity execution object 703 and restarts the processing.

The terminal emulator 307, the virtual memory monitoring feedback 308, the virtual memory 310, and the thread 11022 on the off-load server 101 discontinue processing simultaneously with the disconnection of the radio communication 105. The terminal emulator 307, the virtual memory monitoring feedback 308, the virtual memory 310, and the thread 1102_2 are retained for a specific time period on the off-load server 101 and, after the specific time period elapses, the off-load server 101 releases the memories.

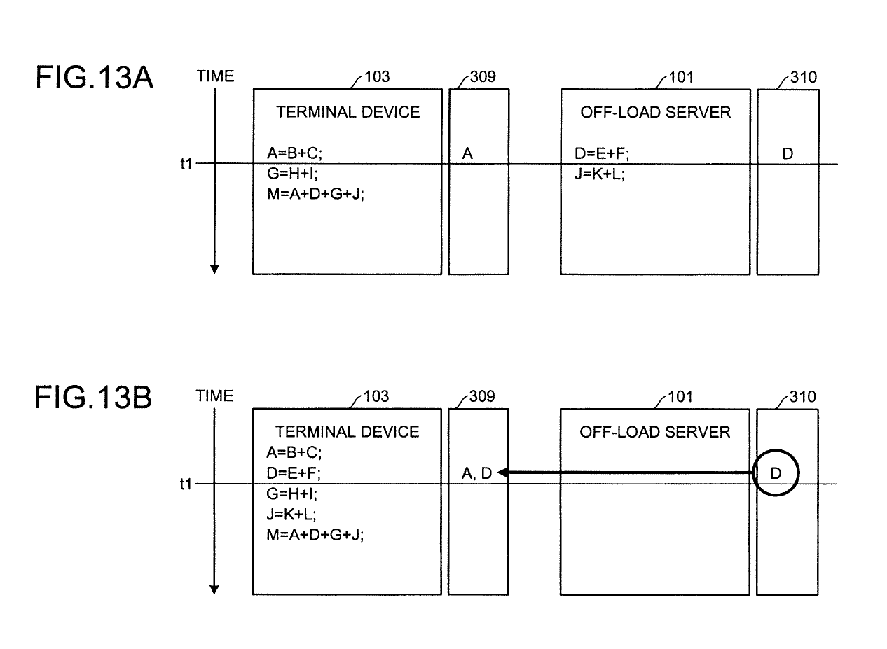

FIGS. 13A and 13B are explanatory diagrams of an example of the data protection executed when the granularity of the parallel processing becomes coarser. FIG. 13A depicts a state before a new execution object is selected. FIG. 13B depicts a state where the new execution object is selected and the execution object to be executed is changed. An example of a case where the granularity of the parallel processing becomes coarser can be a case where the fine granularity execution object 705 is changed to the moderate granularity execution object 704 or where the moderate granularity execution object 704 is changed to the coarse granularity execution object 703. For the example of FIGS. 13A and 13B, the description will be made for the case where the fine granularity execution object 705 is changed to the moderate granularity execution object 704.

In FIG. 13A, the parallel processing control system 100 executes the fine granularity execution object 705 using the apparatuses. For example, the terminal device 103 executes three statements of “A=B+C:”, “G=H+I:”, and “M=A+D+G+J:”. The off-load server 101 executes two statements of “D=E+F:” and “J=K+L:”. At time t1, the terminal device 103 executes “A=B+C:” and stores the value of “A” that is the processing result thereof to the actual memory 309. At time t1, the off-load server 101 executes “D=E+F:” and stores the value of “D” that is the processing result thereof to the virtual memory 310.

At time t1, the execution object to be executed is changed to the moderate granularity execution object 704 and the parallel processing control system 100 is in the state depicted in FIG. 13B. When the granularity of the parallel processing becomes coarser, as a result, the divided processing amount is increased and therefore, the processing is executed intensively in one apparatus. In the state depicted in FIG. 13B, the off-load server 101 does not execute any statements and the terminal device 103 executes the five statements. At this time, the off-load server 101 starts the execution with “G=H+I:”. However, the value of “D” is not present in the actual memory 309 and therefore, the off-load server 101 can not execute “M=A+D+G+J:”.

Therefore, the terminal device 103 sends to the off-load server 101, a transmission request for the result of the processing of the execution object acquired before the change and the off-load server 101 transmits to the terminal device 103, the processing result stored in the virtual memory 310. The terminal device 103 receives the processing result and stores the processing result to the actual memory 309. Thereby, the terminal device 103 can continuously execute the processing even after the change of the execution object to be executed.

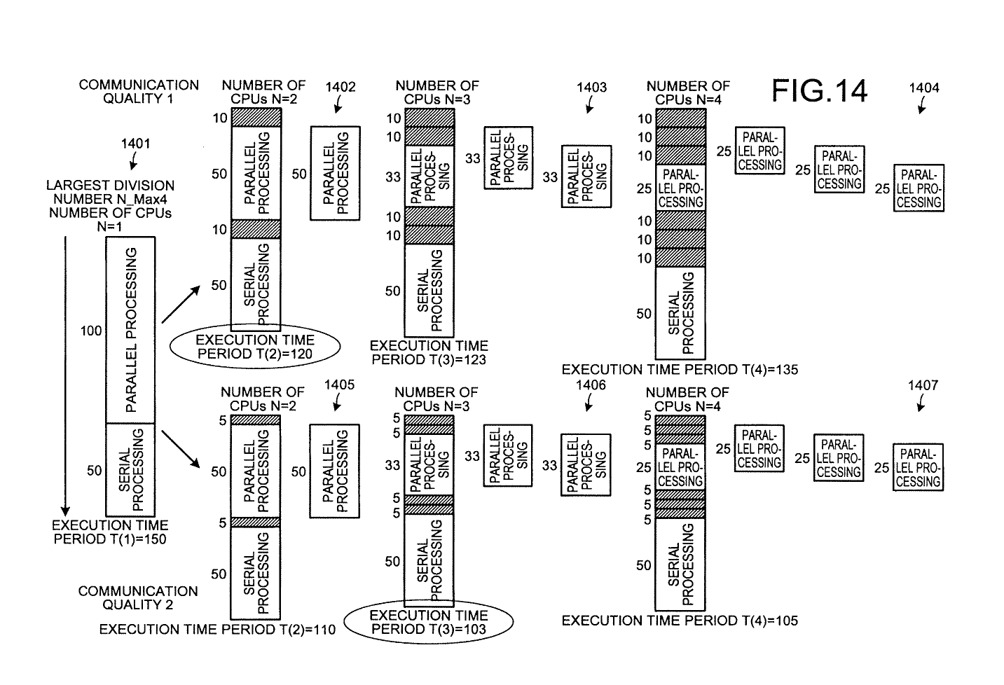

FIG. 14 is an explanatory diagram of an example of the execution time period corresponding to each division number of the parallel processing. FIG. 14 depicts the execution time period corresponding to each division number of the parallel processing acquired when the execution time period of the process 304 is set to be 150 [milliseconds]. The processing time period of the process that can be processed by the parallel processing of the process 304 is set to be 100 [milliseconds] and the processing time period of the serially processed portion thereof assumed to be 50 [milliseconds]. In this case, the rate S of the serial processing is 67 [%]. The largest division number N_Max enabling the parallel execution of the process 304 is set to be four.

An example of the execution time period will be described for a case where the band σ has communication quality 1. It is assumed that it takes 10 [milliseconds] to notify another CPU of data when the band σ has the communication quality 1. Executable forms of the process 304 for the communication quality 1 are execution forms 1401, 1402, 1403, and 1404 that respectively are for the number of CPUs N when N=1, N=2, N=3, and N=4.

The execution time period T(1) of the process 304 in the execution form 1401 is 50 [milliseconds] of the processing time period of the serial processing+100 [milliseconds] of the processing time period of the parallel processing=150 [milliseconds]. The execution time period T(2) of the process 304 in the execution form 1402 is 50 [milliseconds] of the processing time period of the serial processing+50 [milliseconds] of the processing time period of the parallel processing+10 [milliseconds]x2 of the communication time period=120 [milliseconds].

Similarly, the execution time period T(3) of the process 304 in the execution form 1403 is 50 [milliseconds] of the processing time period of the serial processing+33 [milliseconds] of the processing time period of the parallel processing+10 [milliseconds]x4 of the communication time period=123 [milliseconds]. The execution time period T(4) of the process 304 in the execution form 1404 is 50 [milliseconds] of the processing time period of the serial processing+25 [milliseconds] of the processing time period of the parallel processing+10 [milliseconds]x6 of the communication time period=135 [milliseconds]. From the above, the execution form 1402 among the execution forms 1401 to 1404 achieves the shortest execution time period and therefore, the terminal device 103 executes the parallel processing with 2 CPUs, i.e., N=2.

An example of the execution time period will be described for a case where the band σ has communication quality 2. The band σ becomes twice the communication quality 1 when the band σ has the communication quality 2 and therefore, it is assumed that it takes 5 [milliseconds] to notify the other CPU of data. Executable forms of the process 304 with the communication quality 2 are the execution form 1401 where the number of CPUs N=1, an execution form 1405 where the number of CPUs N=2, an execution form 1406 where the number of CPUs N=3, and an execution form 1407 where the number of CPUs N=4.

The execution time period T(1) of the process 304 in the execution form 1401 is 150 [milliseconds] as above. The execution time period T(2) of the process 304 in the execution form 1405 is 50 [milliseconds] of the processing time period of the serial processing+50 [milliseconds] of the processing time period of the parallel processing+5 [milliseconds]×2 of the communication time period=110 [milliseconds].

Similarly, the execution time period T(3) of the process 304 in the execution form 1406 is 50 [milliseconds] of the processing time period of the serial processing+33 [milliseconds] of the processing time period of the parallel processing+5 [milliseconds]×4 of the communication time period=103 [milliseconds]. The execution time period T(4) of the process 304 in the execution form 1407 is 50 [milliseconds] of the processing time period of the serial processing+25 [milliseconds] of the processing time period of the parallel processing+5 [milliseconds]×6 of the communication time period=105 [milliseconds]. From the above, the execution form 1406 of the execution forms 1405 to 1407 achieves the shortest execution time period and therefore, the terminal device 103 executes the parallel processing with the number of CPUs N that is N=3.

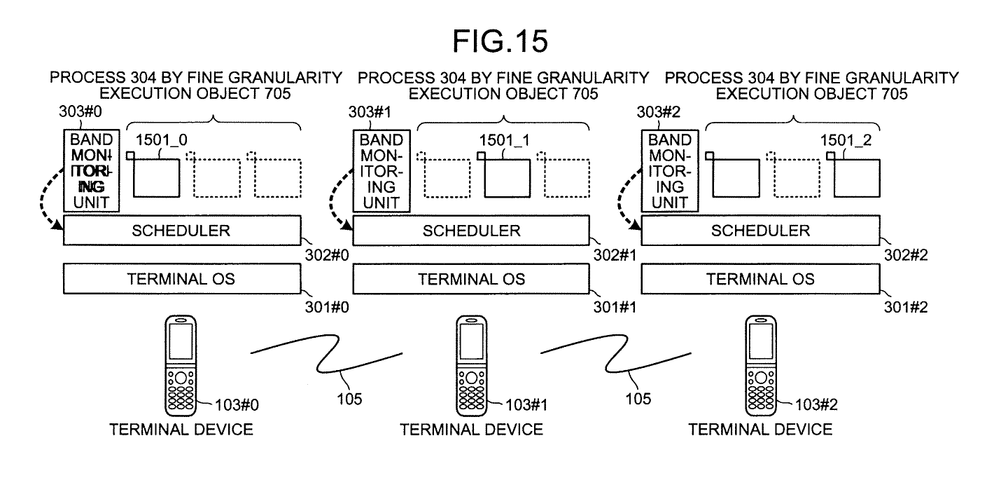

The parallel processing control system 100 according to the first embodiment has the off-load server 101 and the terminal device 103. A parallel processing control system 100 according to a second embodiment includes another terminal device that executes parallel processing for the off-load server 101. The terminal device 103 and the other terminal device are connected by ad-hoc connection. As to the functions of the parallel processing control system 100 according to the second embodiment, the other terminal device has the functions that the off-load server 101 has as depicted in FIG. 6. In the description with reference to FIG. 15, the terminal device 103 according to the first embodiment will be referred to as “terminal device 103#0”; and apparatuses each having the functions of the off-load server 101 according to the first embodiment will be referred to as “terminal device 103#1” and “terminal device 103#2”.

The terminal devices 103#0 and 103#1 may each be an independent mobile terminal or may form one separate-type mobile terminal. For example, the terminal device 103#0 mainly operates as a display and a display of the terminal device 103#1 is a touch panel and operates as a keyboard. A user may use the terminal devices 103#0 and 103#1 physically connecting or separating these terminals to/from each other.

When the connection origin apparatus and the connection destination apparatus are connected to each other by the ad-hoc connection, a detecting unit 606 according to the second embodiment may detect that the execution of the parallel processing is started. For example, when the terminal device 103#0 to be the connection origin apparatus and the terminal device 103#1 to be the connection destination apparatus are connected to each other by the ad-hoc connection, the detecting unit 606 detects that the execution of the parallel processing has started. The result of the detection is stored to a register or a cache memory of the terminal device 103#0 or RAM thereof.

When the detecting unit 606 according to the second embodiment detects that the execution of the parallel processing has started, a selecting unit 604 according to the second embodiment may select an execution object whose granularity is the finest as an execution object to be executed. For example, when it is detected that the execution of the parallel processing has started when the ad-hoc connection is employed, the selecting unit 604 selects the fine granularity execution object 705. The result of the selection is stored to the register or the cache memory of the terminal device 103#0 or the RAM thereof.

FIG. 15 is an explanatory diagram of the execution state of the parallel processing control system 100 for the ad-hoc connection according to the second embodiment. In FIG. 15, the terminal devices 103#0 to 103#2 execute the ad-hoc connection using the radio communication 105. A terminal device 301#0, a scheduler 302#0, and a band monitoring unit 303#0 are executed as software on the terminal device 103#0. The terminal devices 103#1 and 103#2 also execute the same software.

With the ad-hoc connection, the communication band among the terminal devices 103#0 to 103#2 is assured and, for example, the connection is enabled at 300 [Mbps]. As described, the parallel processing control system 100 with the ad-hoc connection can acquire the wide band and therefore, distributes the load in the process 304 by the fine granularity execution object 705.

For example, the terminal device 103#0 executes a thread 1501_0 in the process 304; the terminal device 103#1 executes a thread 1501_1 in the process 304; and the terminal device 103#2 executes a thread 1501_2 in the process 304. The parallel processing control system 100 in the ad-hoc communication may select the granularity of the parallel processing based on the communication time period τ and may distribute the load using, for example, the coarse granularity or the moderate granularity execution object. The parallel processing control system 100 in the ad-hoc communication is in the state where all the CPUs in the terminal device 103 connected to each other by the ad-hoc connection are operated as one multi-core processor system.

In the second embodiment, all the CPUs of the terminal device 103 that are connected by the ad-hoc connection form the parallel processing control system 100 as the one multi-core processor system. It is assumed for the parallel processing control system 100 according to a third embodiment that the terminal device 103 is a multi-core processor system. For example, a specific core among the multiple cores in the terminal device 103 operates as the terminal device 103 according to the first embodiment, and the other cores than the specific core form the off-load server 101 and execute the parallel processing. As to the functions of the parallel processing control system 100 according to the third embodiment, the other cores have the functions of the off-load server 101 as depicted in FIG. 6.

A multi-core processor system is a computer system that includes a processor having plural cores. When the plural cores are provided, a single processor having plural cores may be employed or a group of single-core processors in parallel may be employed. In the third embodiment, for simplification of the description, the description will be made taking an example of a group of single-core processors in parallel. The terminal device 103 according to the third embodiment includes three CPUs 201#0 to 201#2, respectively connected by the bus 210.

A measuring unit 602 according to the third embodiment has a function of measuring the band between the specific processor and another processor other than the specific processor among the plural processors. For example, when the CPU 201#0 is employed as the specific processor and the CPU 201#1 is employed as the other processor, the measuring unit 602 measures the speed of the bus 210 that is the band between the CPUs 201#0 and 201#1.

A setting unit 605 according to the third embodiment has a function of setting the execution object to be executed that is selected by the selecting unit 604 to be executable by the specific processor and the other processor in cooperation with each other. For example, when the selecting unit 604 selects the coarse granularity execution object, the setting unit 605 sets the execution object to be executable by the CPUs 201#0 and 201#1 in cooperation with each other.

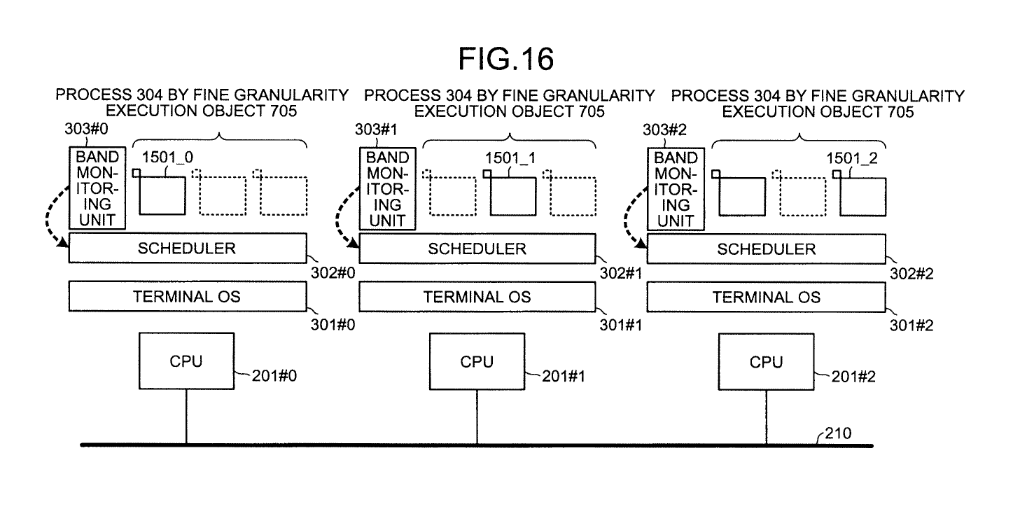

In FIG. 16 described later, the CPU 201#0 operates as the terminal device 103 according to the first embodiment and the CPUs 201#1 and 201#2 operate as the apparatuses each having the functions of the off-load server 101 according to the first embodiment.

The setting unit 605 according to the third embodiment may set the execution object to be executable by a group of processors in cooperation with each other that includes the specific processor that is among the plural processors and has a division number that is the largest. For example, it is assumed that the largest division number is three. In this case, the setting unit 605 sets the execution object to be executable by the CPUs 201#0 and 201#2 in cooperation with each other.

The setting unit 605 according to the third embodiment may set the execution object to be executable by a group of processors in cooperation with each other that includes the specific processor whose number of processors is the number of the parallel execution sessions for the execution object to be executed. For example, it is assumed that the number of parallel execution sessions for the execution object to be executed is two. In this case, the setting unit 605 sets the execution object to be executable by the CPUs 201#0 and 201#1 in cooperation with each other.

FIG. 16 is an explanatory diagram of the execution state of the parallel processing control system 100 for the multi-core processor system according to the third embodiment. In FIG. 16, the CPU 201#0 is connected by the bus 210. The terminal OS 301#0, the scheduler 302#0, and the band monitoring unit 303#0 are under execution as software on the CPU 201#0. The CPUs 201#1 and 201#2 also currently execute the same software.

The transfer speed of the bus 210 is high and it is assumed that, for example, the bus 210 is a peripheral component interconnect (PCI) bus and operates at 32 [bits] and 33 [MHz]. In this case, the transfer speed of the bus 210 is 1,056 [Mbps] and is higher than that of the server connection. As described, the parallel processing control system 100 for the multi-core processor system can acquire the wide band and therefore, distributes the load in the process 304 by the fine granularity execution object 705.

For example, the CPU 201#0 executes the thread 1501_0 in the process 304; the CPU 201#1 executes the thread 1501_1 in the process 304; and the CPU 201#2 executes the thread 1501_2 in the process 304. The parallel processing control system 100 for the multi-core processor system may distribute the load using the moderate granularity execution object 704 or the coarse granularity execution object 703 depending on the specification of the terminal device 103.

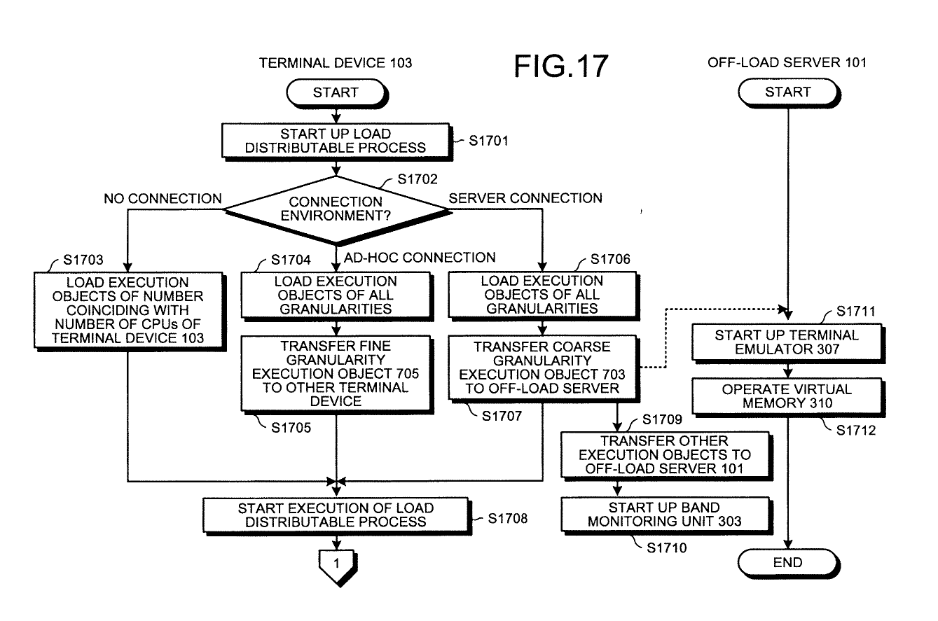

As to the differences among the parallel processing control systems 100 according to the first to the third embodiments, the apparatus executing the off-loading differs to be any one of the off-load server 101, the other terminal device, and the other CPU in the same apparatus and the respective processes do not significantly differ. The processes executed by the parallel processing control systems 100 according to the first to the third embodiments will collectively be described with reference to FIGS. 17 to 20. When a feature is present that only a specific embodiment among the first to the third embodiments can have, the relevant embodiment will be specified.

FIG. 17 is a flowchart of a start process of the parallel processing by the scheduler. The terminal device 103 starts up a load distributable process in response to a start-up request by a user, an OS, etc. (step S1701) and checks the connection environment (step S1702).

If the terminal device 103 determines that the connection environment is “no connection” and the terminal device 103 is a multi-core processor system (step S1702: NO CONNECTION), the terminal device 103 loads thereon the execution objects of a number that coinciding with the number of CPUs of the terminal device 103 (step S1703). The parallel processing control system 100 according to the third embodiment follows a route for “STEP S1702: NO CONNECTION”. If the terminal device 103 determines that the connection environment is “ad-hoc connection” (step S1702: AD-HOC CONNECTION), the terminal device 103 loads thereon the execution objects of all the granularities (step S1704). The parallel processing control system 100 according to the second embodiment follows a route for “STEP S1702: AD-HOC CONNECTION”. After the loading, the terminal device 103 transfers the fine granularity execution object 705 to the other terminal device (step S1705).

If the terminal device 103 determines that the connection environment is “server connection” (step S1702: SERVER CONNECTION), the terminal device 103 loads thereon the execution objects of all the granularities (step S1706). The parallel processing control system 100 according to the first embodiment follows a route for “STEP S1702: SERVER CONNECTION”. For “server connection”, the terminal device 103 and the off-load server 101 are connected to each other through the mobile telephone network. After the loading, the terminal device 103 transfers the coarse granularity execution object 703 to the off-load server (step S1707). In the background, the terminal device 103 transfers the other execution objects to the off-load server 101 (step S1709) and starts up the band monitoring unit 303 (step S1710).

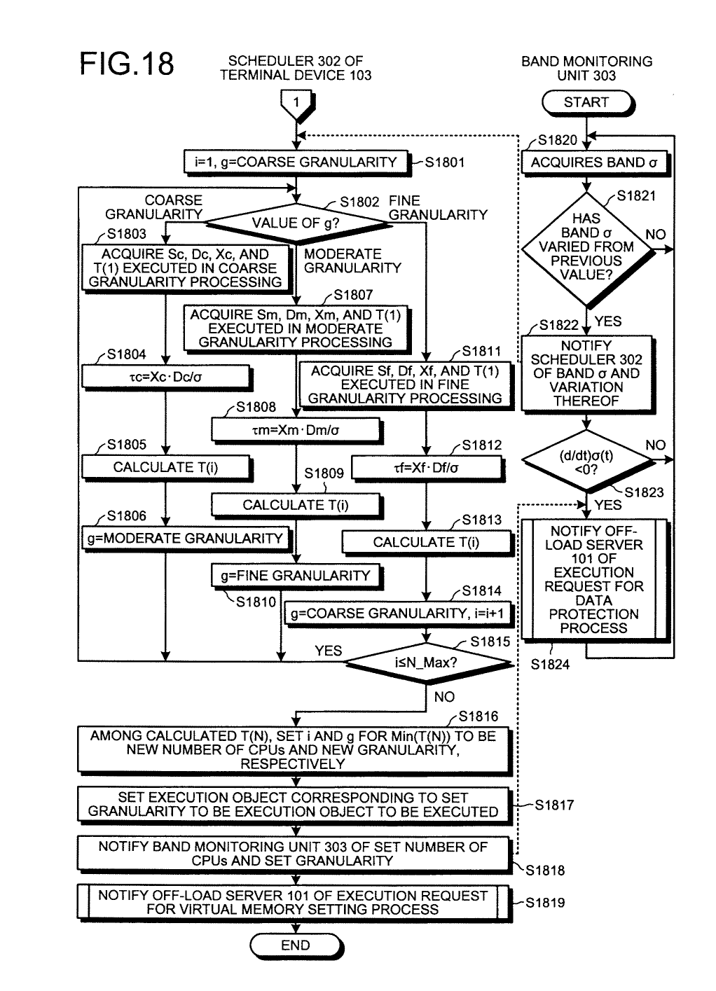

After executing any one of steps S1703, S1705, and S1707, the terminal device 103 starts execution of the load distributable process (step S1708). After starting the execution of the load distributable process, the terminal device 103 executes a parallel processing control process described later with reference to FIG. 18.

When the off-load server 101 receives a notification of the coarse granularity execution object 703 at step S1707, the off-load server 101 starts up the terminal emulator 307 (step S1711) and operates the virtual memory 310 (step S1712). For example, the off-load server 101 receives a notification notifying that the execution object is changed to the coarse granularity execution object 703 and therefore, sets the virtual memory 310 to be the asynchronous virtual memory 1103.

FIG. 18 is a flowchart of the parallel processing control process in the load distributable process executed by the scheduler 302. The parallel processing control process is executed after the process at step S1708 and, in addition, is also executed according to a notification from the band monitoring unit 303. It is assumed for the parallel processing control process of FIG. 18 that the connection environment is “server connection”. For “ad-hoc connection”, the request destination of the processes at steps S1818 and S1824 is the other terminal device.

The terminal device 103 currently executing the band monitoring unit 303 acquires the band σ (step S1820). For example, the terminal device 103 issues “ping” and, thereby, acquires the band σ. After the acquisition, the terminal device 103 determines whether the value of the band o has varied from the previous value thereof (step S1821). If the terminal device 103 determines that the value of the band σ has varied (step S1821: YES), the terminal device 103 notifies the scheduler 302 of the band σ and the variation thereof (step S1822).

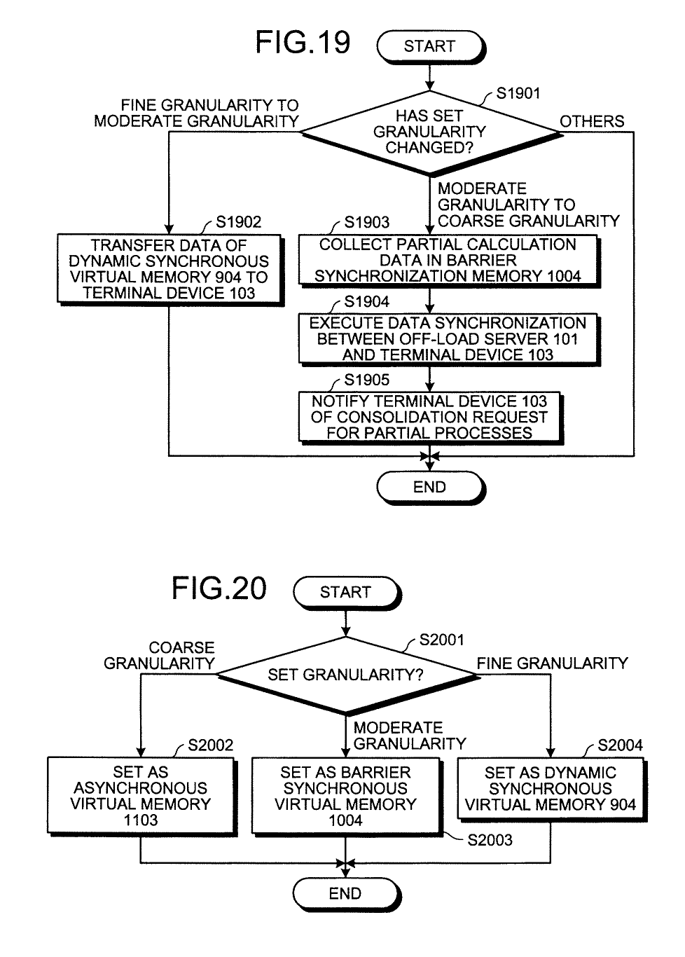

After the notification, the terminal device 103 determines whether temporal variation of the band σ (d/dt)σ(t) is less than zero (step S1823). If the terminal device 103 determines that the temporal variation is less than zero (step S1823: YES), the terminal device 103 notifies the off-load server 101 of an execution request for a data protection process (step S1824). The details of the data protection process will be described later with reference to FIG. 19. After the process at step S1824 comes to an end, if the terminal device 103 determines that the temporal variation of the band σ is greater than or equal to zero (step S1823: NO), or if the terminal device 103 determines that the value of the band σ has not varied (step S1821: NO), the terminal device 103 progresses to the process at step S1820 after a specific time period elapses.

The terminal device 103 receives the notification from the band monitoring unit 303, sets the variable “i” to be one and a variable g to be “coarse granularity” using the scheduler 302 (step S1801), and checks the value of the variable g (step S1802). If the terminal device 103 determines that the variable g is “coarse granularity” (step S1802: COARSE GRANULARITY), the terminal device 103 acquires the rate Sc of the serial processing executed in the coarse granularity processing, the data amount Dc, the data transfer frequency Xc, and the execution time period T(1) for the number of CPU N that is N=1 (step S1803).

After the acquisition, the terminal device 103 calculates the communication time period τc that is τc=Xc·Dc/σ using the band σ notified from the band monitoring unit 303 (step S1804). After the calculation, the terminal device 103 calculates the execution time period T(i) for the number of CPUs N that is N=i using Eq. (1) (step S1805). After the calculation, the terminal device 103 sets the variable g to be “moderate granularity” (step S1806) and progresses to the process at step S1802.

If the terminal device 103 determines that the variable g is “moderate granularity” (step S1802: MODERATE GRANULARITY), the terminal device 103 acquires the rate Sm of the serial processing executed in the moderate granularity processing, the data amount Dm, the data transfer frequency Xm, and the execution time period T(1) for the number of CPU N that is N=1 (step S1807).

After the acquisition, the terminal device 103 calculates the communication time period τm that is τm=Xm·Dm/σ using the band σ notified from the band monitoring unit 303 (step S1808). After the calculation, the terminal device 103 calculates the execution time period T(i) for the number of CPUs N that is N=i using Eq. (1) (step S1809). After the calculation, the terminal device 103 sets the variable g to be “fine granularity” (step S1810) and progresses to the process at step S1802.

If the terminal device 103 determines that the variable g is “fine granularity” (step S1802: FINE GRANULARITY), the terminal device 103 acquires the rate Sf of the serial processing executed in the fine granularity processing, the data amount Df, the data transfer frequency Xf, and the execution time period T(1) for the number of CPU N that is N=1 (step S1811).

After the acquisition, the terminal device 103 calculates the communication time period τf=Xf·Df/σ using the band σ notified from the band monitoring unit 303 (step S1812). After the calculation, the terminal device 103 calculates the execution time period T(i) for the number of CPUs N that is N=i using Eq. (1) (step S1813). After the calculation, the terminal device 103 sets the variable g to be “coarse granularity” and increments the variable i (step S1814), and determines if the variable i is less than or equal to the largest division number N_Max (step S1815). If the terminal device 103 determines that the variable i is less than or equal to the largest division number N_Max (step S1815: YES), the terminal device 103 progresses to the process at step S1802.

If the terminal device 103 determines that the variable i is larger than N_Max (step S1815: NO), the terminal device 103 sets the variables i and g for Min(T(N)) among the calculated T(N) to be new number of CPUs and a new granularity, respectively (step S1816) and sets the execution object corresponding to the set granularity to be the execution object to be executed (step S1817). After the setting, the terminal device 103 notifies the band monitoring unit 303 of the set number of CPUs and the set granularity (step S1818).

After the notification, the terminal device 103 notifies the off-load server 101 of an execution request for a virtual memory setting process (step S1819). The details of the virtual memory setting process will be described later with reference to FIG. 20. After the notification, the terminal device 103 causes the parallel processing control process to come to an end and executes the load distributable process using the set execution object to be executed. The off-load server 101 also executes the load distributable process using the set execution object to be executed. Even when plural off-load servers 101 are present, all the off-load servers 101 execute the load distributable process using the same execution object to be executed.

The value of the largest division number N_Max differs depending on the granularity and therefore, the terminal device 103 may determine for the process at step S1815 using the maximal value of the largest division number Nc_Max for the coarse granularity, the largest division number Nm_Max for the moderate granularity, and the largest division number Nf_Max for the fine granularity. When the variable i to be the number of parallel execution sessions for a granularity exceeds the largest division number for the granularity, the terminal device 103 may skip the process for the corresponding portion. For example, when the largest division number for the coarse granularity Nc_Max is Nc_Max=2 and the variable i is i=3, the terminal device 103 does not execute the processes at steps S1803 to S1805, executes the process at step S1806, and progresses to the process for the moderate granularity.

FIG. 19 is a flowchart of the data protection process. The data protection process is executed by the off-load server 101 or the other terminal device. In an example of FIG. 19, for simplification of the description, the description will be made assuming that the data protection process is executed by the off-load server 101.

The off-load server 101 determines whether the set granularity has changed (step S1901). If the off-load server 101 determines that the set granularity has changed from the fine granularity to the moderate granularity (step S1901: FINE GRANULARITY TO MODERATE GRANULARITY), the off-load server 101 transfers the data of the dynamic synchronous virtual memory 904 to the terminal device 103 (step S1902). After the transfer, the off-load server 101 causes the data protection process to come to an end.

If the off-load server 101 determines that the set granularity has changed from the moderate granularity to the coarse granularity (step S1901: MODERATE GRANULARITY TO COARSE GRANULARITY), the off-load server 101 collects the partial calculation data in the barrier synchronization memory 1004 (step S1903). If the number of CPUs N is greater than or equal to three, plural barrier synchronization virtual memories 1004 may be present and therefore, the off-load server 101 collects the partial calculation data of the barrier synchronization virtual memories 1004.

After the collection, the off-load server 101 executes data synchronization between the off-load server 101 and the terminal device 103 (step S1904). After the synchronization, the off-load server 101 notifies the terminal device 103 of a consolidation request for partial processes (step S1905). For example, when the granularity is changed, the process 304 by the moderate granularity execution object 704 calculates the calculation data of a specific index in the loop. Therefore, the terminal device 103 consolidates the partial processes corresponding to the index for which the calculation comes to an end, and executes the partial processes that correspond to the index for the unprocessed portion. After giving notification of the consolidation request, the off-load server 101 causes the data protection process to come to an end.

If the granularity has not changed or if the off-load server 101 determines that the set granularity has changed from the fine granularity to the moderate granularity or from the moderate granularity to the coarse granularity (step S1901: OTHERS), the off-load server 101 causes the data protection process to come to an end.

FIG. 20 is a flowchart of a virtual memory setting process. Similar to the data protection process, the virtual memory setting process is also executed by the off-load server 101 or the other terminal device. In the example in FIG. 20, for simplification of the description, the description will be made assuming that the virtual memory setting process is executed by the off-load server 101. When the data protection process is under execution at the start of the virtual memory setting process, the off-load server 101 starts the virtual memory setting process after waiting for the data protection process to come to an end.

The off-load server 101 checks the set granularity (step S2001). If the off-load server 101 determines that the set granularity is the coarse granularity (step S2001: COARSE GRANULARITY), the off-load server 101 sets the virtual memory 310 to be the asynchronous virtual memory 1103 (step S2002). If the off-load server 101 determines that the set granularity is the moderate granularity (step S2001: MODERATE GRANULARITY), the off-load server 101 sets the virtual memory 310 to be the barrier synchronous virtual memory 1004 (step S2003). If the off-load server 101 determines that the set granularity is the fine granularity (step S2001: FINE GRANULARITY), the off-load server 101 sets the virtual memory 310 to be the dynamic synchronous virtual memory 904 (step S2004).

After causing the processes at steps S2002 to S2004 each to come to an end, the off-load server 101 causes the virtual memory setting process to come to an end and continues the operation of the virtual memory 310.

As described, according to the parallel processing control program, the information processing apparatus, and the parallel processing control method, an object is selected from a group of objects whose granularities of the parallel processing differ from each other, based on the execution time period calculated from the band between the terminal device and the other apparatus. Thereby, the optimal parallel processing corresponding to the band can be executed; and the processing performance can be improved.

For example, a case is assumed where the parallel processing control system provides global positioning system (GPS) information and the terminal device can received the GPS information. When the band between the terminal device and the off-load server is narrow or the line therebetween is disconnected, the terminal device starts up application software to use the GPS information and executes computing processes associated with the GPS information such as the coordinate calculation. When the band between the terminal device and the off-load server is a wide band, the terminal device off-loads the coordinate calculation to the off-load server. In this manner, the parallel processing control system can execute high-speed processing using the off-load server for a wide band, and can continue the processing using the terminal device for a narrow band.

A case is assumed as another example where the parallel processing control system provides services such as file sharing and streaming. When the band between the terminal device and the off-load server is narrow, the server providing the services transmits compressed data and the terminal device executes the decompression of the data in its full-power mode. When the band between the terminal device and the off-load server is wide, the off-load server decompresses the data and transmits the resulting decompressed data; and the terminal device displays the result. The terminal device only has to display the result and therefore, the power for CPU is unnecessary. Therefore, the terminal device can be operated in its low-power mode.

The execution object with the shortest execution time period may be selected as the execution object to be executed. Thereby, the execution object with the shortest execution time period can be selected among the group of objects whose granularities of the parallel processing differ from each other and therefore, the processing performance can be improved.

The execution time period may also be calculated by calculating the communication time period from the band and the communication amount; calculating the processing time period for the parallel processing from the processing time period and the rate of serial processing acquired when the process for parallel processing is serially executed; and the largest division number enabling the parallel execution; and adding the communication time period and the processing time period for the parallel execution. Thereby, the execution object can be selected that achieves the shortest processing time period including the overhead of the communication time period generated by the parallel processing. Therefore, the processing performance can be improved.

In a case where the execution object to be executed is changed, if the granularity of the new execution object to be executed is coarser than that of the execution object before the change, the processing result retained in the other apparatus may be transmitted to the terminal device and stored in the storage device of the terminal device. Thereby, the interim result of the execution by the other apparatus can be acquired, enabling the terminal device to continue the processing executed by the other apparatus such as the off-load server. This effect is especially effective for the parallel processing control system according to the first embodiment whose band significantly varies between the terminal device and the other apparatus.

When the execution object whose granularity is the coarsest is selected as the execution object to be executed; and a decrease of the band is detected, the processing result retained by the other apparatus may be transmitted to the terminal device and stored in the storage device of the terminal device. Thereby, when it is anticipated that the line is disconnected, the terminal device stores therein in advance the data of the other apparatus such as the off-load server and thereby, can continue the processing using the stored data even when the line is disconnected.

When the terminal device and the other apparatus are connected to each other through the mobile telephone network and the start of the execution of the parallel processing is detected, the execution object whose granularity is the coarsest may be selected as the execution object to be executed. When the connection between the terminal device and the other apparatus is established through the mobile telephone network, the band at the start is narrow and therefore, the execution object whose granularity is coarse is selected in advance, whereby the execution object matched with the band at the start can be set. This effect is effective for the parallel processing control system according to the first embodiment.

When the terminal device and the other apparatus are connected to each other by the ad-hoc connection and the start of the execution of the parallel processing is detected, the execution object whose granularity is the finest may be selected as the execution object to be executed. With the ad-hoc connection, the band at the start is wide and therefore, the execution object whose granularity is fine is selected in advance, whereby the execution object matched with the band at the start can be set. This effect is effective for the parallel processing control system according to the second embodiment.

For the parallel processing control system concerning the multi-core processor according to the third embodiment, the object is also selected based on the execution time period calculated from the band between the terminal device and the other apparatus, from the group of objects whose granularities of the parallel processing differ from each other. Thereby, the optimal parallel processing can be executed corresponding to the band and the processing performance can be improved. The band between the processors is a wide band and therefore, the fine granularity execution object can be executed; and the processing performance can be improved.

A case is assumed where a processor other than the master processor causes access contention to occur at the bus due to the process, etc., under execution by the other processor. In this case, when the master processor measures the band, the response of the other processor to the measurement is delayed and therefore, the band is decreased. Consequently, the master processor has to select the execution object whose granularity is coarser and therefore, the communication amount due to the parallel processing is decreased. Therefore, the access contention can be alleviated.

The parallel processing control systems according to the first to the third embodiments can be mixed with each other to be operated. For example, the terminal device including the plural processors may execute the server connection or the ad-hoc connection and may provide services by the parallel processing as the parallel processing control system according to the first or the second embodiment.

The parallel processing control method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

The parallel processing control program, the information processing apparatus, and the parallel processing control method enable proper parallel processing to be executed according to band and improved performance.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing a parallel processing control program causing a connection origin processor to execute a process comprising:
measuring a band between the connection origin apparatus and a connection destination apparatus;
calculating, based on the measured band, an execution time period for each execution object for which parallel processing is executable by the connection origin processor in the connection origin apparatus and a connection destination processor in the connection destination apparatus, the execution objects having granularities of the parallel processing that differ from each other;
selecting from among the execution objects and based on a length of each calculated execution time period, an execution object to be executed; and
setting the selected execution object to be executable by the connection origin processor and the connection destination processor in cooperation with each other.

2. The computer-readable recording medium according to claim 1, wherein
the selecting includes selecting, as the execution object to be executed, an execution object whose length of the execution time period is shortest among the execution time periods.

3. The computer-readable recording medium according to claim 1, wherein
the calculating includes calculating the execution time period for each of the execution objects by:
calculating a communication time period from the band and a communication amount necessary for the parallel processing,
calculating for each of the execution objects, a processing time period for parallel execution from a processing time period necessary for serially executing the parallel processing, a rate of serial processing in the parallel processing, and a largest division number enabling the parallel execution in the parallel processing, and
adding the communication time period and the processing time period for the parallel execution, and
the setting includes setting the execution object to be executed to be executable by a group of processors in cooperation with each other, the group is among groups of processors of the connection origin apparatus and the connection destination apparatus, includes a specific connection origin processor and a specific connection destination processor, and has the largest division number.

4. The computer-readable recording medium according to claim 3, wherein
the calculating includes calculating an execution time period for each number of sessions of the parallel execution for each of the execution objects by:
calculating a processing time period for the parallel execution based on a processing time period for the serial execution, a rate of the serial processing, and the number of sessions of the parallel execution that is less than or equal to the largest division number, and
adding the communication time period and the processing time period for the parallel execution, and
the setting includes setting the execution object to be executed to be executable by a group of processors in cooperation with each other, the group is among groups of processors of the connection origin apparatus and the connection destination apparatus, includes a specific connection origin processor and a specific connection destination processor, and includes processors of a number equivalent to the number of sessions of the parallel execution in the execution object to be executed.

5. The computer-readable recording medium according to claim 1, the process further comprising:
detecting that a new execution object to be executed having a granularity that is coarser than that of the execution object to be executed has been selected;
notifying the connection destination apparatus of a transmission request for a processing result of the execution object and retained by the connection destination apparatus, when at the detecting, it is detected that the new execution object to be executed has been selected; and
storing to a storage device of the connection origin apparatus, the processing result obtained consequent to the transmission request.

6. The computer-readable recording medium according to claim 1, the process further comprising:
detecting a state where the band has decreased, when an execution object having a granularity that is coarsest is selected as the execution object to be executed;
notifying the connection destination apparatus of a transmission request for a processing result of the execution object and retained by the connection destination apparatus, when at the detecting, the state is detected; and
storing to a storage device of the connection origin apparatus, the processing result obtained consequent to the transmission request.

7. The computer-readable recording medium according to claim 1, the process further comprising
detecting that execution of the parallel processing has started, when the connection origin apparatus and the connection destination apparatus are connected to each other through a mobile telephone network, wherein
the selecting includes selecting, as the execution object to be executed, an execution object having a granularity that is coarsest, when at the detecting, it is detected that the execution of the parallel processing has started.

8. The computer-readable recording medium according to claim 1, the process further comprising
detecting that execution of the parallel processing has started, when the connection origin apparatus and the connection destination apparatus are connected to each other by ad-hoc connection, wherein
the selecting includes selecting, as the execution object to be executed, an execution object having a granularity that is finest, when at the detecting, it is detected that the execution of the parallel processing has started.

9. A computer-readable recording medium storing a parallel processing control program causing a specific processor to execute a process comprising:
measuring a band between the specific processor and another processor other than the specific processor;
calculating, based on the measured band, an execution time period for each execution object for which parallel processing is executable by the specific processor and the other processor, the execution objects having granularities of the parallel processing that differ from each other;
selecting from among the execution objects and based on a length of each calculated execution time period, an execution object to be executed; and
setting the selected execution object to be executable by the specific processor and the other processor in cooperation with each other.

10. The computer-readable recording medium according to claim 9, wherein
the selecting includes selecting, as the execution object to be executed, an execution object whose length of the execution time period is shortest among the execution time periods.

11. The computer-readable recording medium according to claim 9, wherein
the calculating includes calculating the execution time period for each of the execution objects by:
calculating a communication time period from the band and a communication amount necessary for the parallel processing,
calculating for each of the execution objects, a processing time period for parallel execution from a processing time period necessary for serially executing the parallel processing, a rate of serial processing in the parallel processing, and a largest division number enabling the parallel execution in the parallel processing, and
adding the communication time period and the processing time period for the parallel execution, and
the setting includes setting the execution object to be executed to be executable by a group of processors in cooperation with each other, the group is among the processors, includes the specific, and has the largest division number.

12. The computer-readable recording medium according to claim 11, wherein
the calculating includes calculating an execution time period for each number of sessions of the parallel execution for each of the execution objects by:
calculating a processing time period for the parallel execution based on a processing time period for the serial execution, a rate of the serial processing, and the number of sessions of the parallel execution that is less than or equal to the largest division number, and
adding the communication time period and the processing time period for the parallel execution, and
the setting includes setting the execution object to be executed to be executable by a group of processors in cooperation with each other, the group is among the processors, includes the specific processor, and includes processors of a number equivalent to the number of sessions of the parallel execution in the execution object to be executed.

13. An information processing apparatus comprising a processor configured to:
measure a band between the information processing apparatus and a connection destination apparatus;
calculate, based on the measured band, an execution time period for each execution object for which parallel processing is executable by the processor in the information processing apparatus and a connection destination processor in the connection destination apparatus, the execution objects having granularities of the parallel processing that differ from each other;
select from among the execution objects and based on a length of each calculated execution time period, an execution object to be executed; and
set the selected execution object to be executable by the processor and the connection destination processor in cooperation with each other.

14. An information processing apparatus comprising a processor configured to:
measure a band between a specific processor and another processor other than the specific processor;
calculate, based on the measured band, an execution time period for each execution object for which parallel processing is executable by the specific processor and the other processor, the execution objects having granularities of the parallel processing that differ from each other;
select from among the execution objects and based on a length of each calculated execution time period, an execution object to be executed; and
set the selected execution object to be executable by the specific processor and the other processor in cooperation with each other.

15. A parallel processing control method executed by a connection origin processor, the parallel processing control method comprising:
measuring a band between the connection origin apparatus and a connection destination apparatus;
calculating, based on the measured band, an execution time period for each execution object for which parallel processing is executable by the connection origin processor in the connection origin apparatus and a connection destination processor in the connection destination apparatus, the execution objects having granularities of the parallel processing that differ from each other;
selecting from among the execution objects and based on a length of each calculated execution time period, an execution object to be executed; and
setting the selected execution object to be executable by the connection origin processor and the connection destination processor in cooperation with each other.

16. A parallel processing control method executed by a specific processor, the parallel processing control method comprising:
measuring a band between the specific processor and another processor other than the specific processor;
calculating, based on the measured band, an execution time period for each execution object for which parallel processing is executable by the specific processor and the other processor, the execution objects having granularities of the parallel processing that differ from each other;
selecting from among the execution objects and based on a length of each calculated execution time period, an execution object to be executed; and
setting the selected execution object to be executable by the specific processor and the other processor in cooperation with each other.
